(19) United States
(12) Patent Application Publication
(10) Pub. No.: US 2022/0392006 A1
(43) Pub. Date: Dec. 8, 2022

(54) INFORMATION PROCESSING SYSTEM, SYSTEM, AND INFORMATION PROCESSING METHOD

(71) Applicant: Yoshihiro OGURA, Kanagawa (JP)

(72) Inventor: Yoshihiro OGURA, Kanagawa (JP)

(21) Appl. No.: 17/737,026

(22) Filed: May 5, 2022

(30) Foreign Application Priority Data
Jun. 2, 2021 (JP) 2021-092846

(51) Int. Cl. G06Q 50/20

(52) U.S. Cl. CPC G06Q 50/205

(57) ABSTRACT

A service use system includes circuitry to set, for each of a plurality of attribute types, a corresponding one of a plurality of connection destinations of a service. Each of the plurality of attribute types is to be obtained from a user terminal reading a touch point through which the service is to be provided. Each of the plurality of connection destinations is indicated by connection destination information with which the user terminal is to be connected to the corresponding one of the plurality of connection destinations. The circuitry generates touch point information to be obtained in response to the user terminal reading the touch point. The touch point information includes the connection destination information.

### CROSS-REFERENCE TO RELATED APPLICATION

This patent application is based on and claims priority pursuant to 35 U.S.C. § 119(a) to Japanese Patent Application No. 2021-092846, filed on Jun. 2, 2021, in the Japan Patent Office, the entire disclosure of which is hereby incorporated by reference.

### BACKGROUND

### Technical Field

Embodiments of the present disclosure relate to an information processing system, a system, and an information processing method.

### Related Art

A cloud service with which a user easily uses a service registered in advance by reading, using, for example, a smartphone, a QR code or a tag identification (ID) set in a device or a living room or embedded online is known.

For example, a smartphone transmits an ID read from a tag or a QR code and a user ID to a server, and the server provides a service associated with a combination of the ID and the user ID to a user or a device.

### SUMMARY

An exemplary embodiment of the present disclosure includes an information processing system including circuitry to set, for each of a plurality of attribute types, a corresponding one of a plurality of connection destinations of a service. Each of the plurality of attribute types is to be obtained from a user terminal reading a touch point through which the service is to be provided. Each of the plurality of connection destinations is indicated by connection destination information with which the user terminal is to be connected to the corresponding one of the plurality of connection destinations. The circuitry generates touch point information to be obtained in response to the user terminal reading the touch point. The touch point information includes the connection destination information.

An exemplary embodiment of the present disclosure includes a system including an administrator terminal including administrator terminal circuitry and an information processing system including information processing system circuitry. The administrator terminal circuitry receives input of combinations of each of a plurality of attribute types and a corresponding one of a plurality of connection destinations of a service. The administrator terminal circuitry transmits, to the information processing system circuitry, the combinations of each of the plurality of attribute types and the corresponding one of the plurality of connection destinations. The information processing system circuitry sets, for each of the plurality of attribute types, the corresponding one of the plurality of connection destinations of the service, based on the combinations of each of the plurality of attribute types and the corresponding one of the plurality of connection destinations. Each of the plurality of attribute types is to be obtained from a user terminal reading a touch point through which the service is to be provided. Each of the plurality of connection destinations is indicated by connection destination information with which the user terminal is to be connected to the corresponding one of the plurality of connection destinations. The information processing system circuitry generates touch point information to be obtained in response to the user terminal reading the touch point. The touch point information includes the connection destination information indicating each of the plurality of connection destinations for a corresponding one of the plurality of attribute types.

An exemplary embodiment of the present disclosure includes an information processing method including setting, for each of a plurality of attribute types, one of a plurality of connection destinations of a service. Each of the plurality of attribute types is obtained from a user terminal reading a touch point through which the service is to be provided. Each of the plurality of connection destinations is indicated by connection destination information with which the user terminal is to be connected to a corresponding one of the plurality of connection destinations. The information processing method includes generating touch point information to be obtained in response to the user terminal reading the touch point. The touch point information includes the connection destination information indicating each of the plurality of connection destinations corresponding one of the plurality of attribute types.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an overall configuration of a service use system according to an exemplary embodiment;

FIG. 2 is a diagram illustrating an outline of a process performed by the service use system according to the exemplary embodiment;

FIG. 3 is a block diagram illustrating a hardware configuration of an information processing system according to the exemplary embodiment;

FIG. 4 is a diagram illustrating a hardware configuration of each of a user terminal and an administrator terminal according to the exemplary embodiment;

FIG. 5 is a block diagram illustrating a functional configuration of the service use system according to the exemplary embodiment;

FIG. 6 is a conceptual diagram illustrating an example of a linked service management table according to the exemplary embodiment;

FIG. 7 is a conceptual diagram illustrating an example of an administrator information management table according to the exemplary embodiment;

FIG. 8A and FIG. 8B are conceptual diagrams each illustrating an example of a touch point management table according to the exemplary embodiment;

FIG. 9 is a conceptual diagram illustrating an example of an attribute management table according to the exemplary embodiment;

FIG. 10 is a conceptual diagram illustrating an example of a connection service management table according to the exemplary embodiment;

FIG. 11 is a sequence diagram illustrating an example of a process of linking with a service according to the exemplary embodiment;

FIG. 12 is a diagram illustrating an example of a login screen displayed on the administrator terminal according to the exemplary embodiment;

FIG. 13 is a diagram illustrating an example of a top screen displayed on the administrator terminal according to the exemplary embodiment;

FIG. 14 is a flowchart illustrating an example of a process of registering a condition according to the exemplary embodiment;

FIG. 15 is a diagram illustrating an example of a link item selection screen according to the exemplary embodiment;

FIG. 16 is a sequence diagram illustrating an example of a process of registering an attribute type according to the exemplary embodiment;

FIG. 17 is a diagram illustrating an example of an attribute type registration screen according to the exemplary embodiment;

FIG. 18 is a sequence diagram illustrating an example of a process of registering a service type according to the exemplary embodiment;

FIG. 19 is a diagram illustrating an example of a service type registration screen according to the exemplary embodiment;

FIG. 20 is a flowchart illustrating an example of a process of setting for a linked service according to the exemplary embodiment;

FIG. 21 is a diagram illustrating an example of a link setting screen according to the exemplary embodiment;

FIG. 22 is a sequence diagram illustrating an example of a process of selecting an attribute according to the exemplary embodiment;

FIG. 23 is a diagram illustrating an example of an attribute item selection screen according to the exemplary embodiment;

FIG. 24 is a diagram illustrating an example of an attribute type selection screen according to the exemplary embodiment;

FIG. 25 is a sequence diagram illustrating an example of a process of selecting a service type according to the exemplary embodiment;

FIG. 26 is a diagram illustrating an example of a service type selection screen according to the exemplary embodiment;

FIG. 27 is a diagram illustrating an example of settings displayed in a setting display area according to the exemplary embodiment;

FIG. 28 is a diagram illustrating an example of an output content display screen according to the exemplary embodiment;

FIG. 29 is a diagram illustrating an example of touch point information according to the exemplary embodiment;

FIG. 30 is a sequence diagram illustrating an example of a process for using a service according to the exemplary embodiment;

FIG. 31 is a schematic diagram illustrating an example of an attendance management service provided in the service use system according to the exemplary embodiment;

FIG. 32 is a flowchart illustrating an example of a process for using a service in a case where different services are provided according to the exemplary embodiment;

FIG. 33 is a diagram illustrating an example of attendance registration information registered by the attendance management service according to the exemplary embodiment;

FIG. 34 is a schematic diagram illustrating an example of the attendance management service provided in the service use system according to the exemplary embodiment;

FIG. 35 is a flowchart illustrating an example of a process for using a service in a case where different services are provided according to attribute items of role and time according to the exemplary embodiment;

FIG. 36 is a diagram illustrating an example of the attendance registration information registered by the attendance management service according to the exemplary embodiment;

FIG. 37 is a schematic diagram illustrating an example of a submitting service provided in the service use system according to the exemplary embodiment; and

FIG. 38 is a flowchart illustrating an example of a process for using a service in a case where different services are provided according to attribute items of role and time according to the exemplary embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described with reference to the drawings. In the description of the drawings, the same elements are denoted by the same reference numerals, and redundant descriptions thereof are omitted.

### Embodiment

System Configuration:

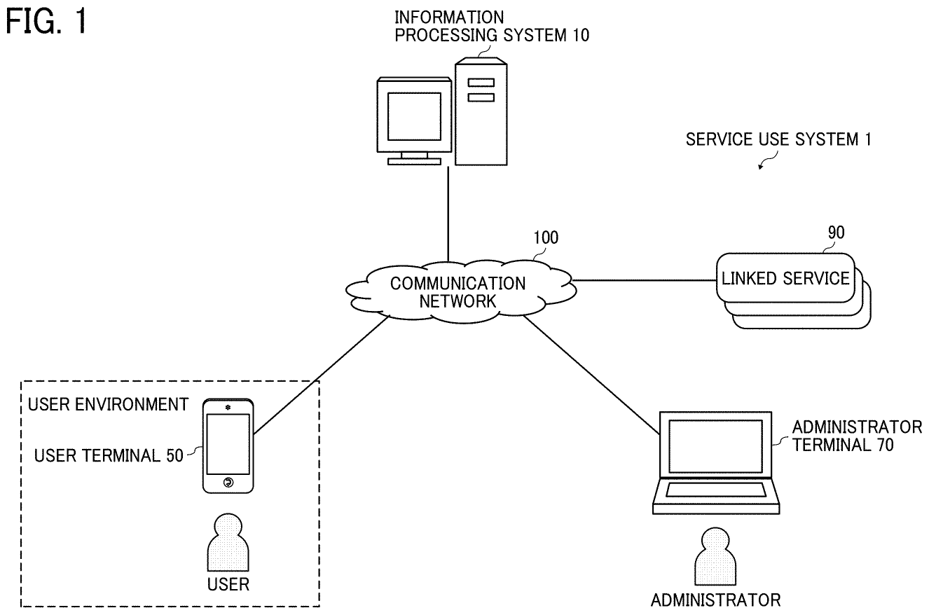

FIG. 1 is a diagram illustrating an example of an overall configuration of a service use system. A service use system 1 illustrated in FIG. 1 is a system in which a user terminal 50 reads a touch point 40 set in a predetermined user environment, and thereby various linked services 90 are available to a user via an information processing system 10.

The service use system 1 includes the information processing system 10, the user terminal 50, and an administrator terminal 70. The information processing system 10, the user terminal 50, and the administrator terminal 70, which are included in the service use system 1, communicates with each other via a communication network 100. The communication network 100 includes the Internet, a mobile communication network, and a local area network (LAN), for example. The communication network 100 includes a network by not only wired communications but also a network by wireless communications such as 3rd generation (3G), 4th generation (4G), 5th generation (5G), Wireless Fidelity (Wi-Fi) (registered trademark), Worldwide Interoperability for Microwave Access (WiMAX) or Long Term Evolution (LTE).

The service use system 1 provides various types of services to the user by connecting the linked service 90, which provides the various types of services via the information processing system 10, to the user terminal 50. The linked service 90 includes a specific type of service to be provided to a user. Such the services include, for example, a service for managing attendance (presences or absences) in a school or an office, a service for submitting an electronic file such as text data or image data, an online ordering service for receiving an order for a product or service from a user by online, an online seat reservation service for receiving a seat reservation in an office, a store, or a public transportation facility. The above-described examples of the linked service 90 are not limiting. The linked service 90 further includes, for example, services for various businesses or operations such as manufacturing industry, construction and civil engineering, real estate, transportation, welfare and care, medical care, sightseeing, retail, and a local government.

The information processing system 10 is a server computer that executes processing for providing a predetermined service to a user who uses the user terminal 50 by cooperating with the linked service 90. The information processing system 10 may be implemented by a single server computer or may be implemented by a plurality of server computers. The description is given of an example in which the information processing system 10 is a server computer that resides in a cloud environment. In another example, the information processing system 10 is a server that resides in an on-premises environment. In some embodiments, the information processing system 10 provides a service to a user by linking with an external linked service 90 operated by another administrator or may be configured by a service providing company that provides a series of services including the linked service 90. In addition, the information processing system 10 may include a device having a server function installed in a user environment.

The user terminal 50 is a computer such as a smartphone used by a user. The user terminal 50 reads the touch point 40 set in the user environment to use a predetermined service provided from the linked service 90. The administrator terminal 70 is a computer such as a laptop personal computer (PC) used by an administrator by who services to be provided to users are settable.

The administrator who uses the administrator terminal 70 may be a specific user who uses the user terminal 50. In this case, the function of the administrator terminal 70 may be included in the user terminal 50 used by the specific user who is the administrator. The user terminal 50 or the administrator terminal 70 is not limited to a smartphone or a laptop PC, and may be, for example, a tablet terminal, a wearable terminal, or a smart watch.

The touch point 40 indicates a contact point between the user terminal 50 carried by the user and a specific service, for providing the specific service to the user. The user terminal 50 reads the touch point 40 to acquire information for accessing the specific service. The service is provided to the user via the information processing system 10 such as a server computer or a device. The touch point 40, which is a contact point, is implemented by, for example, an image, an information medium, and a communication device and provides information. More specifically, the touch point 40 is implemented by an image such as a two-dimensional code including a QR code (registered trademark), an information medium that reads information using short-range communications such as a near field communication (NFC) tag or a radio frequency identification (RFID) tag, or a communication device that transmits information using near-distance wireless communications such as Bluetooth (registered trademark) or ultrasonic waves, for example. The image of the two-dimensional code may be printed on a paper medium or may be displayed on a display device such as a display.

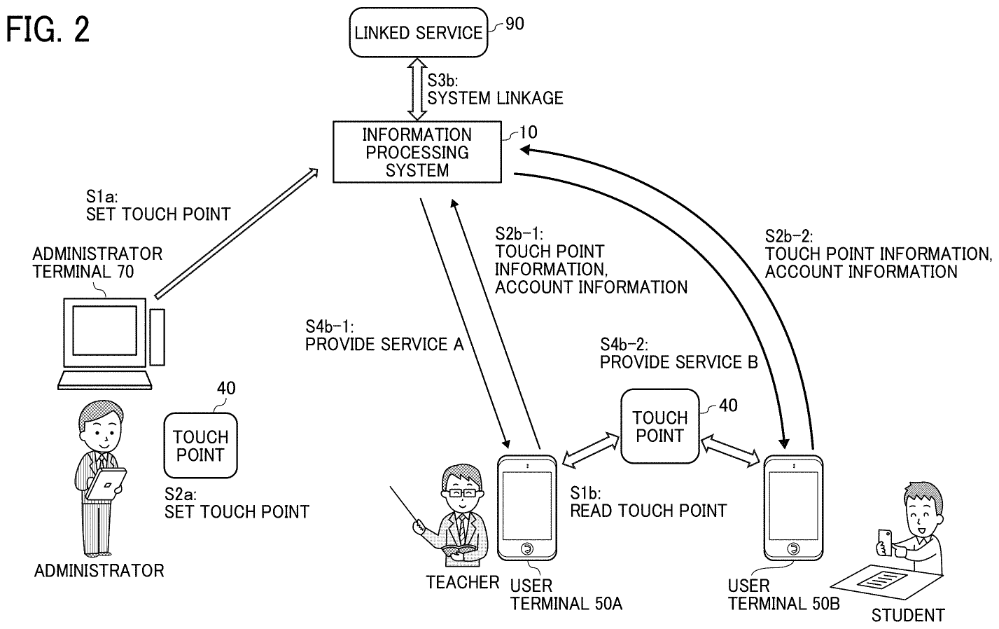

FIG. 2 is a diagram illustrating an example of an outline of a process performed by the service use system. In the example of FIG. 2, each user reads the touch point 40 and uses a predetermined service in a school, which is an example of the user environment. With reference to FIG. 2, the outline of the process of the service use system 1 according to the present embodiment is briefly described. A detailed description of functions implemented by the service use system 1 is given later with reference to other drawings.

The administrator of the service uses the administrator terminal 70 to set a touch point to be read by the user. The administrator terminal 70 sets a touch point with the information processing system 10 according to input operations of the administrator (step S1a). In response to a request from the administrator terminal 70, the information processing system 10 sets the touch point in which an attribute of each user is associated with a connection destination of a type of the service provided for each attribute. Based on settings set with the information processing system 10, the administrator outputs the touch point 40 to be set, or placed, at a desired position in the school (step S2a). The touch point 40 is, for example, an image such as a QR code (registered trademark).

A teacher and a student who attend a lecture at the school use the user terminals 50 (50A and 50B) to read the touch point 40 set by the administrator (step S1b). Then, the user terminals 50A and 50B respectively transmit the read touch point information and the own account information to the information processing system 10 (steps S2b-1 and S2b-2). Based on the touch point information and the account information received from the user terminal 50A and the user terminal 50B, the information process system 10 links with the linked service 90 according to the attributes of the users (step S3b). The information process system 10 provides a service A corresponding to the attribute of teacher to the user terminal 50A used by the teacher (step S4b-1). At the same time, the information processing system 10 provides a service B corresponding to the attribute of student to the user terminal 50B used by the student (step S4b-2).

In a related art with which a service is available by using a touch point such as a QR code, the available service is fixed with the touch point itself, and thereby not supporting a situation in which the available service is desired to be dramatically vary according to a usage form or use scenario of a user.

The service use system 1 according to the present embodiment sets, with the information processing system 10, attributes of users or operation records (for example, reading times) in relation to reading the touch point 40 in manner that each of the attributes is associated with a corresponding one of connection destinations the different services, and provides, based on the attributes of the users or the operation logs including the reading times, the different services for each attribute even when the same touch point 40 is read. In other words, in an environment in which all services may be digitized and cooperatively providable, the service use system 1 allows the users to use not only a service set in advance but also appropriate services according to various attributes or operation logs of the users.

Hardware Configuration:

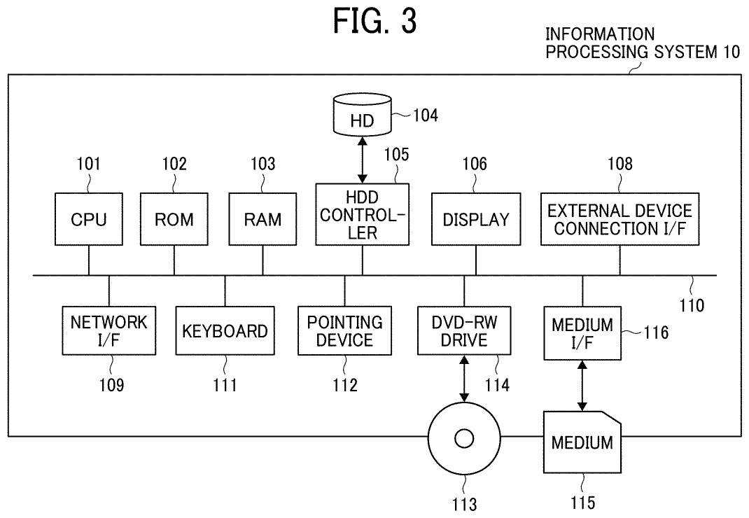

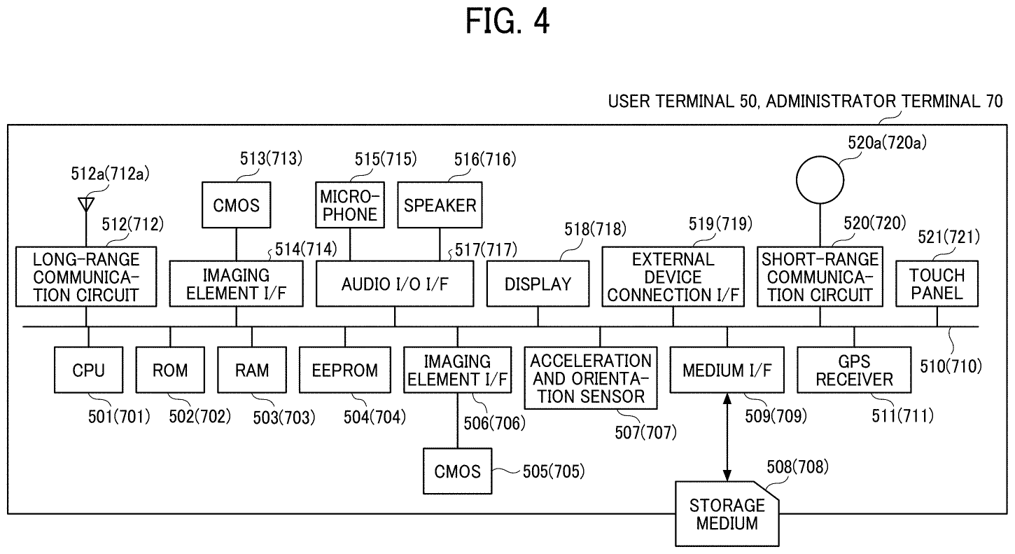

A hardware configuration of a device or a terminal included in the service use system according to the present embodiment is described below with reference to FIG. 3 and FIG. 4. Each hardware configuration of the device or terminal illustrated in FIG. 3 or FIG. 4 may have elements added or deleted as appropriate.

Hardware Configuration of Information Processing System:

FIG. 3 is a block diagram illustrating an example of a hardware configuration of the information processing system. Each hardware element of the information processing system 10 is denoted by a reference numeral in 100 series. The information processing system 10 is implemented by a computer, and as illustrated in FIG. 3, includes a central processing unit (CPU) 101, a read only memory (ROM) 102, a random access memory (RAM) 103, a hard disk (HD) 104, a hard disk drive (HDD) controller 105, display 106, an external device connection interface (I/F) 108, a network (I/F) 109, a bus line 110, a keyboard 111, a pointing device 112, a digital versatile disc rewritable (DVD-RW) drive 114 and a medium I/F 116.

The CPU 101 performs overall control of the information processing system 10. The ROM 102 stores a program used for driving the CPU 101, such as an initial program loader (IPL). The RAM 103 is used as a work area for the CPU 101. The HD 104 stores various data such as a program. The HDD controller 105 controls reading or writing of various data from or to the HD 104 under control of the CPU 101. The display 106 displays various types of information such as a cursor, a menu, a window, characters, or an image. In one example, the display 106 is a touch panel display provided with an input device. The external device connection I/F 108 is an interface for connecting to various external devices. The network I/F 109 is an interface that controls communication of data with an external device through the communication network 100. The bus line 110 is, for example, an address bus or a data bus, which electrically connects the elements such as the CPU 101 illustrated in FIG. 3.

The keyboard 11 is an example of an input device including a plurality of keys for inputting characters, numerical values, or various instructions. The pointing device 112 is an example of an input device that allows a user to select or execute a specific instruction, select processing to be executed, or move a cursor being displayed. The keyboard 111 and the pointing device 112 are merely examples of the input device. As another example of the input device, a touch panel or a voice input device may be used. The DVD-RW drive 114 controls reading or writing of various data from or to a DVD-RW 113, which is an example of a removable recording medium. The removable recording medium is not limited to the DVD-RW and may be a digital versatile disk-recordable (DVD-R), or a BLU-RAY (registered trademark) disc (BLU-RAY disk), for example.

The medium I/F 116 controls reading or writing (storing) of data with respect to a storage medium 115 such as a flash memory.

Hardware Configuration of User Terminal:

FIG. 4 is a block diagram illustrating an example of a hardware configuration of the user terminal. Each hardware element of the user terminal 50 is denoted by a reference numeral in 500 series. The user terminal 50 is implemented by a computer, and as illustrated in FIG. 4, includes a CPU 501, a ROM 502, a RAM 503, an electrically erasable PROM (EEPROM) 504, a complementary metal oxide semiconductor (CMOS) sensor 505, an imaging element I/F 506, an acceleration and orientation sensor 507, a medium I/F 509, and a global positioning system (GPS) receiver 511.

The CPU 501 performs overall control of the user terminal 50. The ROM 502 stores programs such as an initial program loader (IPL) to boot the CPU 501.

The RAM 503 is used as a work area for the CPU 501. The EEPROM 504 reads or writes various data such as a control program for user terminals under control of the CPU 501. The CMOS sensor 505 is an example of a built-in imaging device that captures an object (mainly, a self-image of a user) under control of the CPU 501 and obtains image data. In alternative to the CMOS sensor 505, an imaging element such as a charge-coupled device (CCD) sensor may be used. The imaging element I/F 506 is a circuit that controls driving of the CMOS sensor 505. Examples of the acceleration and orientation sensor 507 include various sensors such as an electromagnetic compass to detect geomagnetism, a gyrocompass, and an accelerometer. The medium I/F 509 controls reading or writing (storing) of data with respect to a storage medium 508 such as a flash memory. The GPS receiver 511 receives a GPS signal from a GPS satellite.

The user terminal 50 further includes a long-range communication circuit 512, a CMOS sensor 513, an imaging element I/F 514, a microphone 515, a speaker 516, an audio input and output (I/O) I/F 517, a display 518, an external device connection I/F 519, a short-range communication circuit 520, an antenna 520a of the short-range communication circuit 520, and a touch panel 521.

The long-range communication circuit 512 is a circuit to communicate with other devices through the communication network 100. The CMOS sensor 513 is an example of a built-in imaging device that captures an object under control of the CPU 501 and obtains image data. The imaging element I/F 514 is a circuit that controls driving of the CMOS sensor 513. The microphone 515 is a built-in circuit that converts sound into electric signals. The speaker 516 is a built-in circuit that converts electric signals into physical vibrations to produce sounds such as music and voice. The audio I/O I/F 517 is a circuit for inputting or outputting audio signals between the microphone 515 and the speaker 516 under control of the CPU 501. The display 518 is an example of a display device that displays an image of an object, various icons, etc. Examples of the display 518 include a liquid crystal display (LCD) and an organic electroluminescence (EL) display. The external device connection I/F 519 is an interface for connecting to various external devices. The short-range communication circuit 520 is a communication circuit such as NFC or Bluetooth. The touch panel 521 is an example of an input device that allows a user to operate the user terminal 50 by touching a screen of the display 518.

The user terminal 50 also includes a bus line 510. The bus line 510 is, for example, an address bus or a data bus, which electrically connects the elements such as the CPU 501 illustrated in FIG. 4.

Hardware Configuration of Administrator Terminal:

FIG. 4 is a block diagram illustrating an example of a hardware configuration of the administrator terminal. Each hardware element of the administrator terminal 70 is denoted by a reference numeral in 700 series. The administrator terminal 70 is implemented by a computer and has substantially the same configuration as that of the user terminal 50 illustrated in FIG. 4, and thus the description of the hardware configuration is omitted.

Each of the above-described control programs may be recorded in a file in a format installable or executable on a computer-readable recording medium for distribution. Examples of the recording medium include, but not limited to, a compact disc recordable (CD-R), a digital versatile disc (DVD), a BLU-RAY (registered trademark) disc, a secure digital (SD) card, and a universal serial bus (USB) memory. In addition, such recording media may be provided in the domestic markets or foreign markets as program products. For example, the information processing system 10 implements an information processing method according to an embodiment of the present disclosure by executing a program according to an embodiment of the present disclosure.

Functional Configuration:

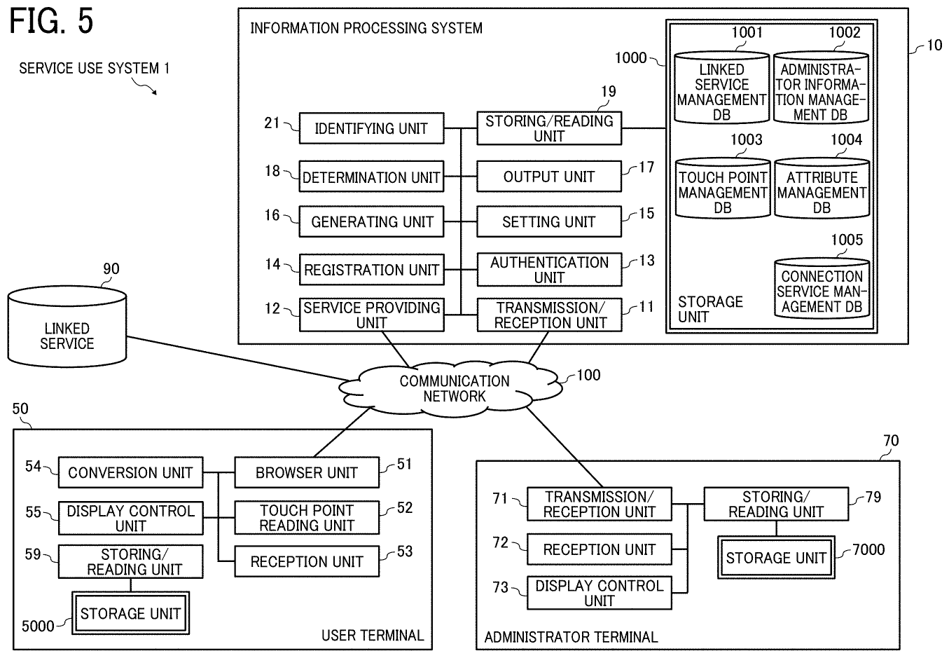

A functional configuration of the service use system according to the present embodiment of the disclosure is described below with reference to FIG. 5 to FIG. 10. FIG. 5 is a block diagram illustrating an example of a functional configuration of the service use system. Note that FIG. 5 illustrates devices or terminals that are illustrated in FIG. 1 and related to processing or operation described below.

Functional Configuration of Information Processing System:

A functional configuration of the information processing system 10 is described below with reference to FIG. 5. The information processing system 10 includes a transmission/reception unit 11, a service providing unit 12, an authentication unit 13, a registration unit 14, a setting unit 15, a generating unit 16, an output unit 17, a determination unit 18, an identifying unit 21, and a storing/reading unit 19. The above-described units are functions implemented by operating any of the hardware elements illustrated in FIG. 3 in cooperation with instructions of the CPU 101 according to the program, which is for information processing systems, expanded to the RAM 103. The information processing system 10 includes a storage unit 1000 implemented by the ROM 102, the HD 104, or the storage medium 115 illustrated in FIG. 3.

The transmission/reception unit 11 is mainly implemented by processing of the CPU 101 in relation to the network I/F 109 and transmits or receives various data or information to or from other devices or terminals through the communication network 100. The service providing unit 12 is mainly implemented by processing of the CPU 101 and provides the various types of services to the user terminal 50 through the touch point 40. The authentication unit 13 is implemented by processing of the CPU 101 and performs authentication processing to authenticate each of the users managed by the information processing system 10.

The registration unit 14 is mainly implemented by processing of the CPU 101 and registers attribute types and service types that are sorted when the linked service 90 is used through the touch point 40. The setting unit 15 is mainly implemented by processing of the CPU 101 and sets an attribute type and a service type associated with the touch point 40. The generating unit 16 is mainly implemented by processing of the CPU 101 and generates, based on various types of information set by the setting unit 15, touch point information that is information obtained when the user terminal 50 reads the touch point 40.

The output unit 17 is mainly implemented by processing of the CPU 101 and outputs the touch point information generated by the generating unit 16. The method of outputting the touch point information includes various output methods according to a form of the touch point 40, and includes, for example, printing, displaying, writing to an information medium, and setting with a communication device. For example, in a case where the touch point 40 is an image such as a two-dimensional code, the output unit 17 outputs the touch point information by printing the image on a paper medium or displaying the image on a display. In addition, in a case where the touch point 40 is an information medium that reads information using short-range communications by an NFC tag or an RFID tag, the output unit 17 outputs the touch point information by writing the touch point information in the information medium, for example. In addition, in a case where the touch point 40 is a communication device that transmits information using short-range wireless communications such as BLUETOOTH or ultrasonic waves, the output unit 17 outputs the touch point information by setting the communication device to transmit the touch point information, for example. The determination unit 18 is implemented by processing of the CPU 101 and executes various determinations. The identifying unit 21 is implemented by processing of the CPU 101 and identifies a service type to be provided to a user based on a corresponding attribute type of a user who has read the touch point 40.

The storing/reading unit 19 is mainly implemented by processing of the CPU 101 and stores various types of data or information in the storage unit 1000 or reads various types of data or information from the storage unit 1000.

Linked Service Management Table:

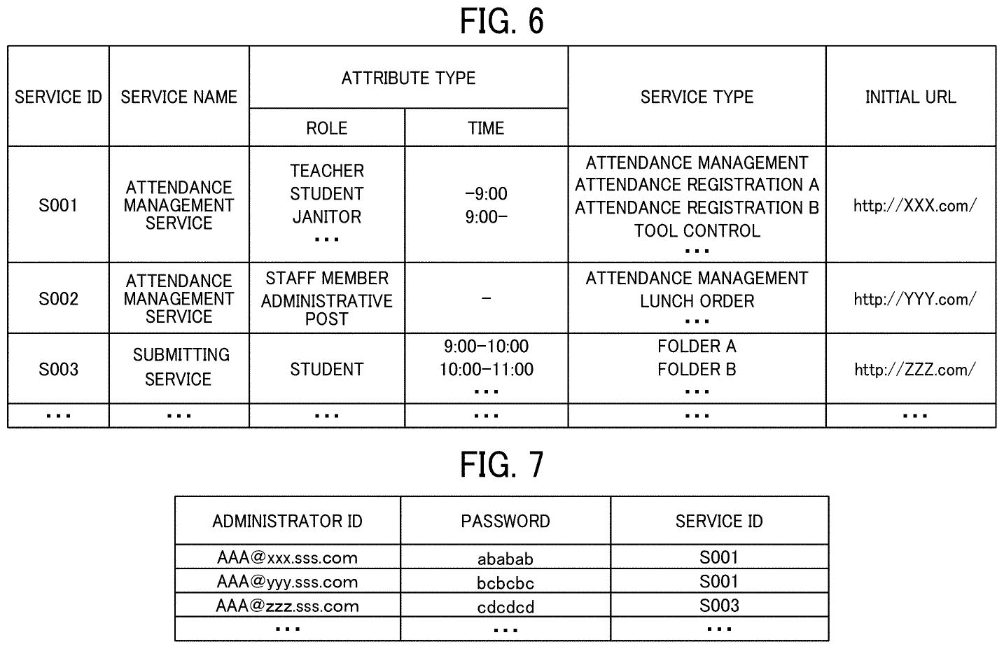

FIG. 6 is a conceptual diagram illustrating an example of the linked service management table. The linked service management table is a table for managing the linked services 90 that are to be linked with the information processing system 10. The storage unit 1000 includes a linked service management database (DB) 1001 including the linked service management table as illustrated in FIG. 6.

In the linked service management table, linked service information in which an information record includes information items of service ID, service name, attribute type, service type, and initial uniform resource locator (URL) that are associated with each other. The service ID and the service name identify the linked service 90, the attribute type indicates attribute types to each of which the service is provided by the linked service 90, the service type indicates different service types in the linked service 90, and the URL is for accessing the linked service 90. The attribute type indicates information registered for each attribute item to which a link setting is performed. In the example of FIG. 6, a corresponding attribute type is registered for each linked service 90. More specifically, as an attribute item, a role of the user who reads the touch point 40 and a reading time indicating a time at which the touch point 40 is read are registered. In the following description of the presented embodiment, as the attribute item, which is used to for classification in the linked service 90, at least one of a role and a time is used. However, this is not limiting, and in another example, the attribute item may include an item corresponding to a reading place indicating a place at which the touch point 40 is read or an operation log of a user with a terminal that has read the touch point 40.

Administrator Information Management Table:

FIG. 7 is a conceptual diagram illustrating an example of the administrator information management table. The administrator information management table is a table for managing various types of information related to an administrator who has authority to perform a link setting of a service to be provided through the touch point 40. The storage unit 1000 includes an administrator information management DB 1002 including the administrator information management table as illustrated in FIG. 7.

In the administrator information management table, an administrator ID and a password for identifying the administrator, and a service ID for identifying the linked service 90 of which the link setting is performable by the administrator are associated with each other. The administrator ID is account information such as an e-mail address of the administrator.

Touch Point Management Table:

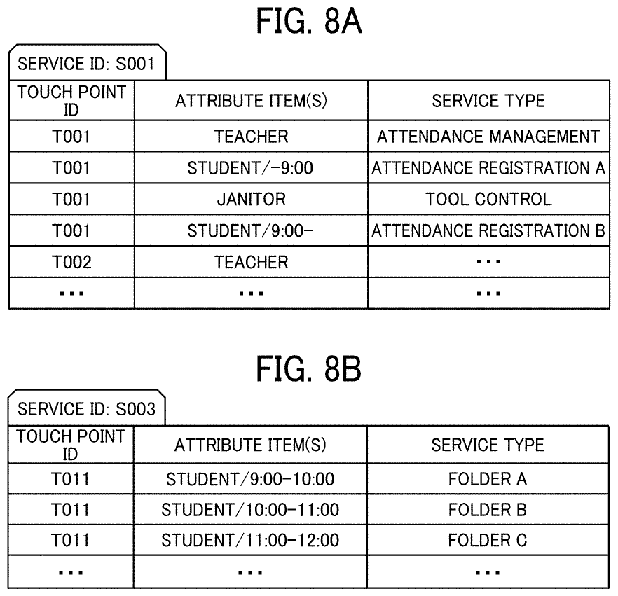

FIG. 8A and FIG. 8B are conceptual diagrams each illustrating an example of the touch point management table. The touch point management table is a table for managing various types of information set for each touch point 40. The storage unit 1000 includes a touch point management DB 1003 including the touch point management table as illustrated in FIG. 8B.

In the touch point management table, a touch point ID for identifying the touch point 40, an attribute type indicating a type of an attribute to be provided by the linked service 90, and a service type indicating a type of a different service in the linked service 90 in association with each service ID for identifying the linked service 90.

The touch point management table illustrated in FIG. 8A is associated with a service ID “S001” and manages information set to the touch point 40 that provides the linked service 90 corresponding to the service ID “S001 (ATTENDANCE MANAGEMENT SERVICE).” In the example of FIG. 8A, with respect to a touch point ID of “T001,” an attribute type of “TEACHER” and a service type of “ATTENDANCE MANAGEMENT” are associated with each other, and an attribute type of “STUDENT/−9:00” and a service type of “ATTENDANCE MANAGEMENT A” are associated with each other. In addition, in the example of FIG. 8A, with respect to the touch point ID “T001,” an attribute type of “JANITOR” and a service type of “TOOL CONTROL” are associated with each other, and an attribute type of “STUDENT/9:00−” and a service type of “ATTENDANCE MANAGEMENT B” are associated with each other.

The touch point management table illustrated in FIG. 8B is associated with a service ID “S003” and manages information set to the touch point 40 that provides the linked service 90 corresponding to the service ID “S003 (SUBMITTING SERVICE).” In the example of FIG. 8B, with respect to a touch point ID of “T003,” an attribute type of “STUDENT/9:00-10:00” and a service type of “FOLDER A” are associated with each other, an attribute type of “STUDENT/10:00-11:00” and a service type of “FOLDER B” are associated with each other, and an attribute type of “STUDENT/11:00-12:00” and a service type of “FOLDER C” are associated with each other.

As described above, with the touch point management table in which different combinations of the attribute types and the service types are set and mongered for a single touch point 40, each of different types of services are to be provided to a corresponding user who has read the touch point 40 according to a role of the user and a reading time.

Attribute Management Table:

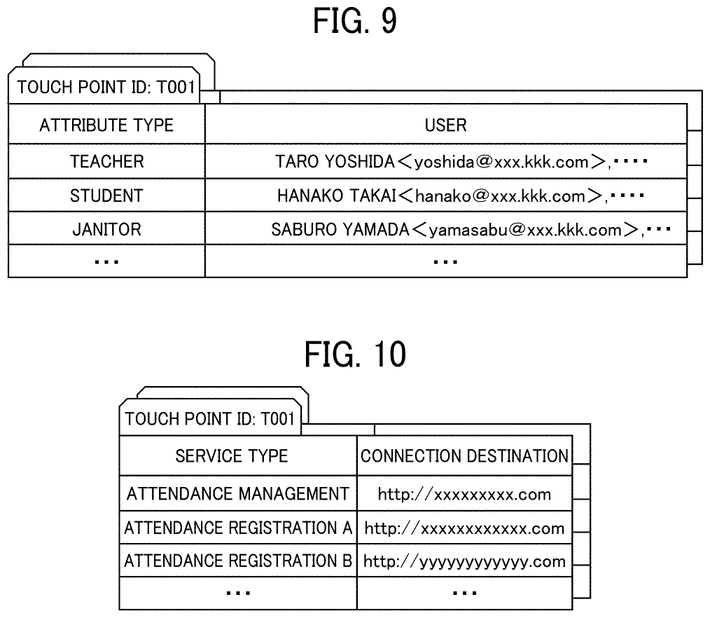

FIG. 9 is a conceptual diagram illustrating an example of the attribute management table. The storage unit 1000 includes an attribute management DB 1004 including the attribute management table as illustrated in FIG. 9.

The attribute management table includes attribute information in which an attribute type indicating a type of an attribute to which the linked service 90 is provided and a user who is belonging to the attribute type are associated with each other for each touch point ID for identifying the touch point 40. Each user is identified by account information (for example, an e-mail address) of the user corresponding to the attribute type, for example. In the example of FIG. 9, attribute types associated with touch point ID of “T001” include “TEACHER,” “STUDENT,” and “JANITOR,” and account information of each of the users corresponding to one of the attribute types is registered. The account information of the user is an example of user identification information for identifying the user.

Connection Service Management Table:

FIG. 10 is a conceptual diagram illustrating an example of a connection service management table. The storage unit 1000 includes a connection service management DB 1005 including the connection service management table as illustrated in FIG. 10.

The connection service management table includes connection service information in which a service type indicating one of a plurality of service types of the linked service 90 and connection destination information indicating a connection destination corresponding to the service type are associated with each other for each touch point ID identifying the touch point 40. The connection destination information is, for example, a URL for accessing a connection service corresponding to the service type. In the example of FIG. 10, “ATTENDANCE MANAGEMENT,” “ATTENDANCE REGISTRATION A,” and “ATTENDANCE REGISTRATION B” are included as service types associated with the touch point ID of “T001,” and URLs corresponding to the respective service types are registered as the connection destination information.

Functional Configuration of User Terminal:

A functional configuration of the user terminal 50 is described below with reference to FIG. 5. The user terminal 50 includes a browser unit 51, a touch point reading unit 52, a conversion unit 53, a reception unit 54, a display control unit 55, and a storing/reading unit 59. The above-described units are functions implemented by operating any of the hardware elements illustrated in FIG. 4 in cooperation with instructions of the CPU 501 according to the program, which is for user terminals, expanded to the RAM 503 from the EEPROM 504. The user terminal 50 includes a storage unit 5000 implemented by the ROM 502 or the storage medium 508 illustrated in FIG. 4.

The browser unit 51 is mainly implemented by processing of the CPU 501 and is implemented by a general web browser. The touch point reading unit 52 is mainly implemented by processing of the CPU 501, reads the touch point 40, and activates the browser unit 51. The method of reading the touch point 40 corresponds to the method of providing information from the touch point 40. For example, when the touch point 40 is an image of a two-dimensional code, the touch point reading unit 52 reads the touch point 40 by capturing the image. In addition, in a case where the touch point 40 is an information medium that reads information using short-range communications by an NFC tag or an RFID tag, the touch point reading unit 52 reads the touch point 40 by reading the information by short-range communications, for example. In addition, in a case where the touch point 40 is a communication device that transmits information using near-distance wireless communications such as BLUETOOTH or ultrasonic waves, the touch point reading unit 52 reads the touch point 40 by receiving the information by near-distance wireless communications, for example.

The conversion unit 53 is mainly implemented by instructions of the CPU 501 and recognize and decodes the touch point 40 to converts the image into text. The reception unit 54 is mainly implemented by processing of the CPU 501 and receives various selections or inputs from the user. The display control unit 55 is mainly implemented by processing of the CPU 501 and causes a display unit such as the display 518 to display various screens.

The storing/reading unit 59 is mainly implemented by processing of the CPU 501 and stores various data or information in the storage unit 5000 or reads various data or information from the storage unit 5000.

Functional Configuration of Administrator Terminal:

A functional configuration of the administrator terminal 70 is described below with reference to FIG. 5. The administrator terminal 70 includes a transmission/reception unit 71, a reception unit 72, a display control unit 73, and a storing/reading unit 79. The above-described units are functions implemented by operating any of the hardware elements illustrated in FIG. 4 in cooperation with instructions of the CPU 701 according to the program, which is for administrator terminals, expanded to the RAM 703 from the EEPROM 704. The administrator terminal 70 includes a storage unit 7000 implemented by the ROM 702 or the storage medium 708 illustrated in FIG. 4.

The transmission/reception unit 71 is mainly implemented by processing of the CPU 701 in relation to the long-range communication circuit 712 and transmits or receives various data or information to or from other devices or terminals through the communication network 100.

The reception unit 72 is mainly implemented by processing of the CPU 701 and receives various selections or inputs from the administrator. The display control unit 73 is mainly implemented by processing of the CPU 701 and causes a display unit such as the display 718 to display various screens.

The storing/reading unit 79 is mainly implemented by processing of the CPU 701 and stores various data or information in the storage unit 7000 or reads various data or information from the storage unit 7000.

Processes or Operation:

Process of Linking with Service:

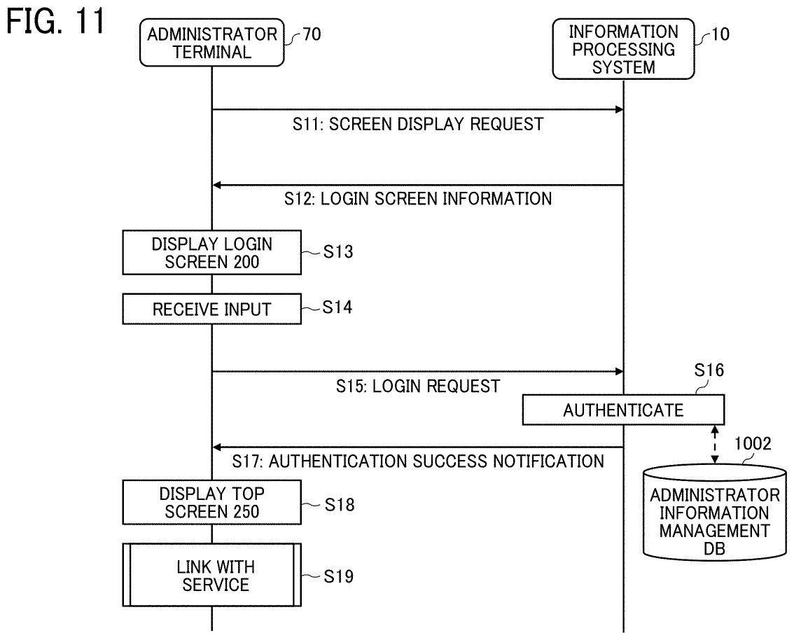

Processes and operations performed by the service use system according to the present embodiment is described below with reference to FIG. 11 to FIG. 38. A process of linking with a service in relation to a predetermined service to be provided through the touch point 40 in the service use system 1 is described with reference to FIG. 11 to FIG. 29. FIG. 11 is a sequence diagram illustrating an example of the process of linking with a service.

The transmission/reception unit 71 of the administrator terminal 70 transmits a screen display request to the information processing system 10 in response to a predetermined input operation performed by the administrator (step S11). The transmission/reception unit 11 of the information processing system 10 receives the screen display request transmitted from the administrator terminal 70. Then, the transmission/reception unit 11 of the information processing system 10 transmits login screen information for displaying a login screen to the administrator terminal 70 that is a request source (step S12). The transmission/reception unit 71 of the administrator terminal 70 receives the login screen information transmitted from the information processing system 10.

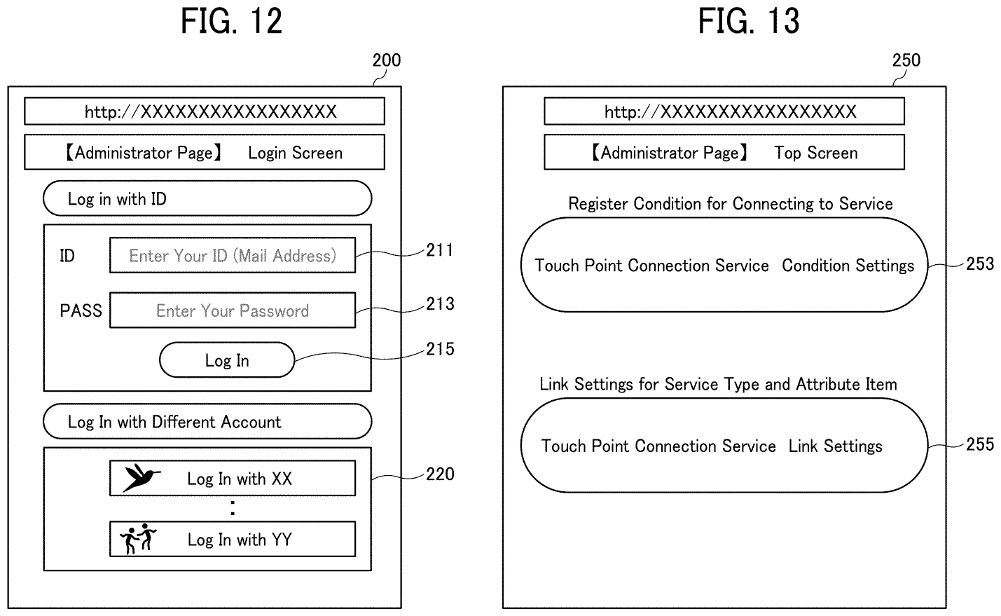

Subsequently, based on the login screen information received in step S12, the display control unit 73 of the administrator terminal 70 causes a display unit such as the display 718 to display a login screen 200 for logging in to an administrator page of a connection service through the touch point 40 (step S13). FIG. 12 is a diagram illustrating an example of the login screen displayed on the administrator terminal. A login screen 200 illustrated in FIG. 12 includes an input field 211 for inputting an administrator ID, an input field 213 for inputting a password, and a login button 215 that is pressed to perform login. In the input field 211, an e-mail address of the administrator is input as the administrator ID. In addition, the login screen 200 includes an account linking section 220 that is selected when login is performed with an account of an external service such as the linked service 90.

Subsequently, the reception unit 72 receives the administrator ID and the password by input operations to the input fields 211 and 213 performed by the administrator (step S14). When the administrator presses the login button 215, the transmission/reception unit 71 transmits a login request to the information processing system 10 (step S15). The login request includes the administrator ID and the password input in step S14. The transmission/reception unit 11 of the information processing system 10 receives the login request transmitted from the administrator terminal 70.

Then, the authentication unit 13 of the information processing system 10 searches the administrator information management DB 1002 (see FIG. 7) using the administrator ID and the password included in the login request received in step S15 as search keys. Subsequently, the authentication unit 13 authenticates the administrator by determining whether the same pair of administrator ID and password is stored in the administrator information management DB 1002 (step S16). In the following description of the present embodiment, a case in which the authentication unit 13 determines that the administrator has a legitimate use authority is described. Further, the storing/reading unit 19 reads the service ID associated with the administrator ID and the passwords of the authenticated administrator from the administrator information management DB 1002.

Then, the transmission/reception unit 11 transmits an authentication success notification indicating that the authentication is successful to the administrator terminal 70 that is a transmission source of the login request (step S17). This authentication success notification includes the service ID read in step S16. The transmission/reception unit 71 of the administrator terminal 70 receives the authentication success notification transmitted from the information processing system 10.

Subsequently, the display control unit 73 of the administrator terminal 70 causes a display unit such as the display 718 to display a top screen 250 of the administrator page of the connection service through the touch point 40 (step S18). FIG. 13 is a diagram illustrating an example of a top screen displayed on the administrator terminal. The top screen 250 illustrated in FIG. 13 includes a condition registration button 253 for registering a condition for connecting to the linked service 90 through the touch point 40, and a link setting button 255 for link settings of a service type and an attribute type in the linked service 90.

Then, the administrator terminal 70 links with the linked service 90 corresponding to a service ID received in S17 (step S19). A detailed description of the process of linking with a service for providing a connection service through the touch point 40 is given below.

Process of Registering Condition:

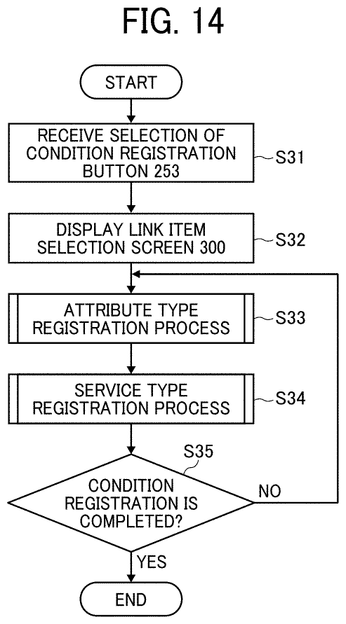

A process for registering a condition for linking with the linked service 90 for which the administrator has authority is described below with reference to FIG. 14 to FIG. 19. FIG. 14 is a flowchart illustrating an example of a condition registration process.

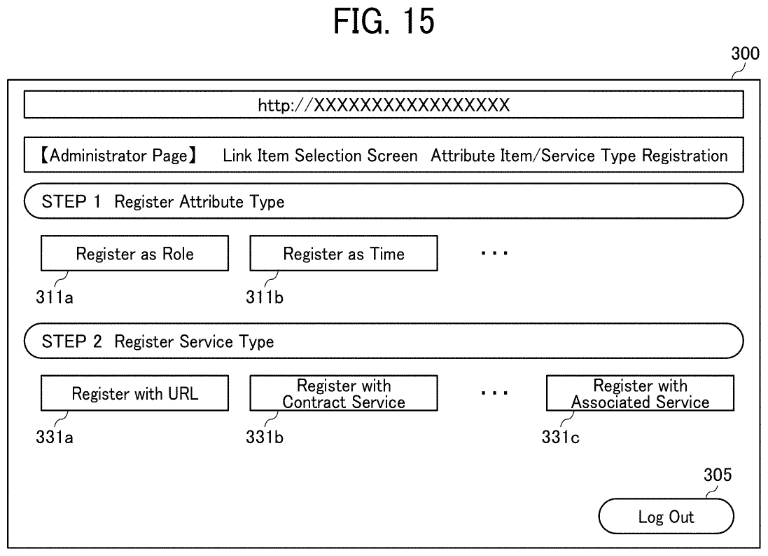

The reception unit 72 of the administrator terminal 70 receives selection of a condition registration button 253 included in the top screen 250 by an input operation of the administrator (step S31). Subsequently, the display control unit 73 causes a display unit such as the display 718 to display a link item selection screen 300 for selecting an item to be linked with the linked service 90 (step S32). FIG. 15 is a diagram illustrating an example of the link item selection screen. The link item selection screen 300 illustrated in FIG. 15 includes attribute item selection buttons 311 (311a, 311b, . . . ) for selecting an attribute item to be registered among linked items, linking method selection buttons 331 (331a, 332b, . . . ) for selecting a method for registering a service type, and a logout button 305 that is pressed for logging out from the administrator page.

The attribute item selection button 311a is a selection button that is pressed when registering a role of the user who has read the touch point 40 as an attribute item, and the attribute item selection button 311b is a selection button that is pressed for registering a reading time of the touch point 40 as an attribute item. The linking method selection button 331a is a selection button that is pressed for registering a service type with a URL, the linking method selection button 331b is a selection button that is pressed for registering a service type with a contract service, and the linking method selection button 331c is a selection button that is pressed for registering a service type with an associated service.

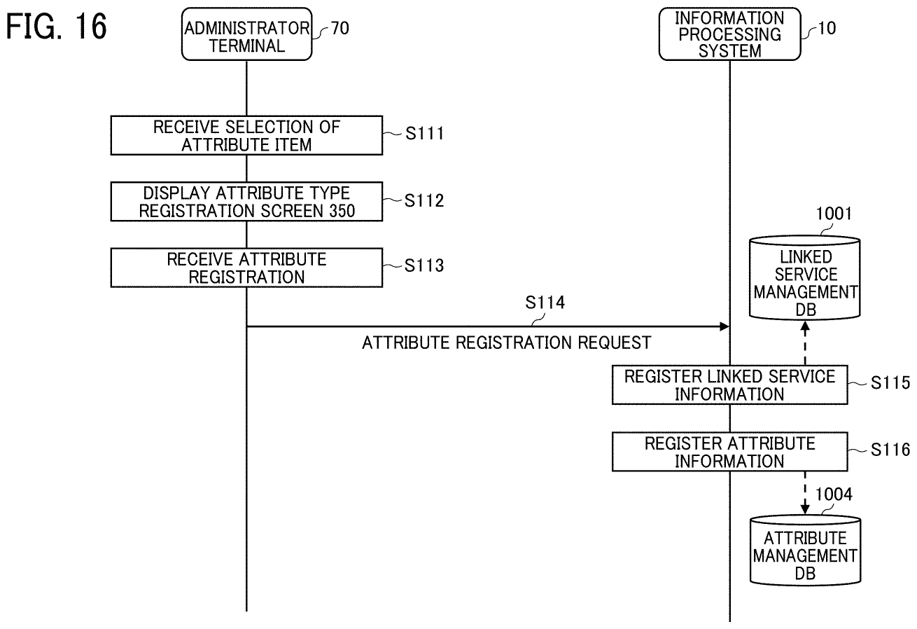

Subsequently, the administrator terminal 70 executes a process of registering an attribute type to be linked with the linked service 90 (attribute type registration process) (step S33). The processing of step S33 is described in detail below with reference to FIG. 16. FIG. 16 is a sequence diagram illustrating an example of the attribute type registration process.

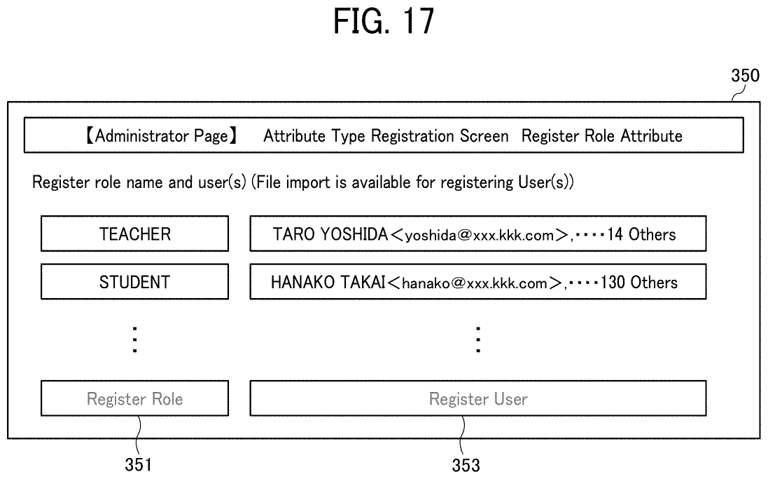

When the administrator presses the attribute item selection button 311 included in the link item selection screen 300, the reception unit 72 of the administrator terminal 70 receives selection of an attribute item (step S111). Subsequently, the display control unit 73 causes a display unit such as the display 718 to display an attribute type registration screen 350 for registering the attribute type among the attribute items selected in step S111 (step S112). FIG. 17 is a diagram illustrating an example of the attribute type registration screen. The attribute type registration screen 350 illustrated in FIG. 17 is displayed when the administrator presses the attribute item selection button 311a in step S111, and is a display screen for registering a role of a user as an attribute item. The attribute type registration screen 350 includes an attribute type registration button 351 for registering a type (name) of role as an attribute item and a user registration button 353 for registering a user belonging to a corresponding type of role.

In the example of FIG. 17, as types of role, for example, teacher and student are registered. In addition, accounts (for example, e-mail addresses) of users corresponding to each of the teacher and the student are registered as users belonging to the corresponding type of role. Although each of roles of users is registered as an attribute item in the example of FIG. 17, the attribute type registration screen 350 applicable to registration of the attribute type even w % ben the attribute item is time, for example. In a case where the attribute item is time, for example, a time zone (for example, 9:00 to 10:00 or 10:00 to 11:00) of a reading time at which the touch point 40 is read is registered as an attribute type.

Then, the reception unit 72 of the administrator terminal 70 receives attribute registration in relation to the linked service 90 according to various input operations performed on the attribute type registration screen 350 by the administrator (step S113). Then, the transmission/reception unit 71 transmits an attribute registration request to the information processing system 10 (step S114). The attribute registration request includes the service ID received in step S17, the attribute types accepted in step S113, and information on the users belonging to each attribute type. The transmission/reception unit 11 of the information processing system 10 receives the attribute registration request transmitted from the administrator terminal 70.

Then, the registration unit 14 of the information processing system 10 registers linked service information associated with the service ID and the information on the attribute types received in step S114 in the linked service management DB 1001 (see FIG. 6) (step S115). More specifically, as illustrated in FIG. 6, the registration unit 14 registers, as the linked service information, a service name of the linked service 90 and information on an initial URL of the linked service 90 along with the service ID and the information on the attribute types, which are received, in the linked service management DB 1001. In addition, the registration unit 14 registers the attribute information in which each attribute type received in step S114 and the information on the user belonging to the corresponding attribute type are associated with each other in the attribute management DB 1004 (see FIG. 9) (step S116). As described above, the information processing system 10 registers the users belonging to each attribute type associated with the linked service 90 that is available through the touch point 40.

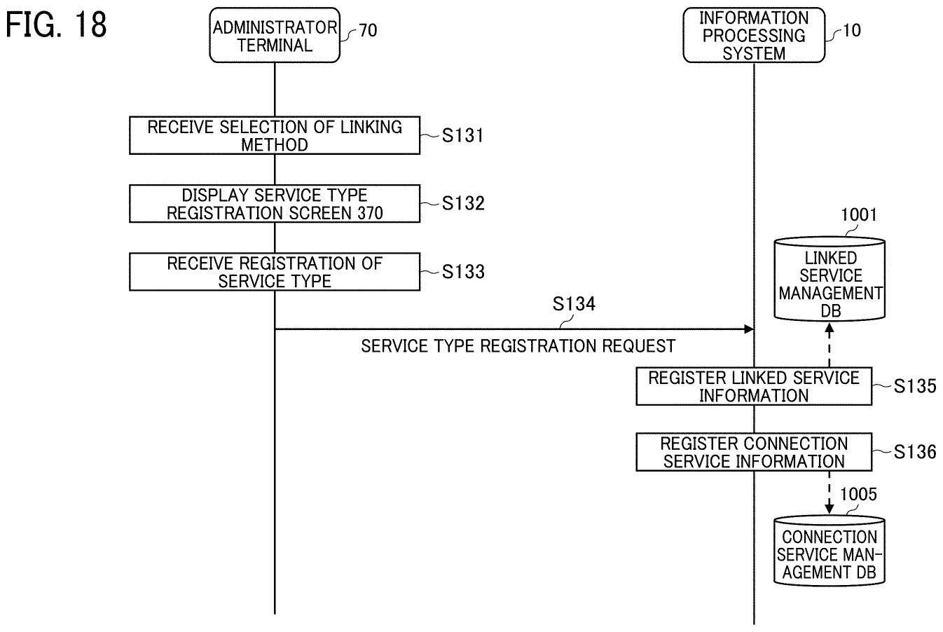

Referring again to FIG. 14, the administrator terminal 70 executes a process of registering a service type in the linked service 90 (step S34). The processing of step S34 is described in detail below with reference to FIG. 18. FIG. 18 is a sequence diagram illustrating an example of the service type registration process.

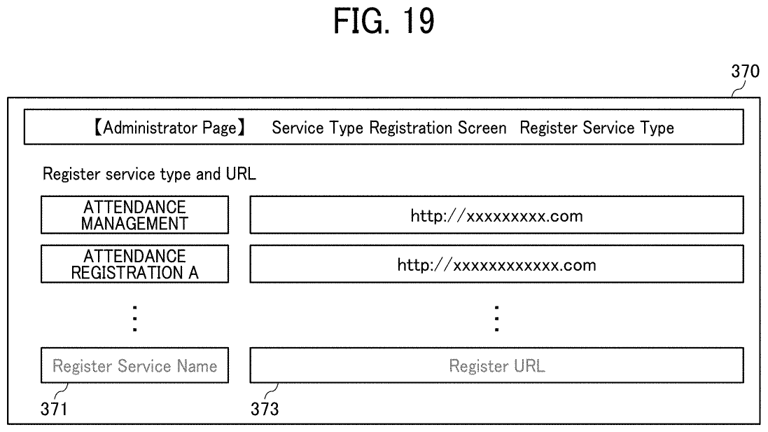

When the administrator presses the linking method selection button 331 included in the link item selection screen 300, the reception unit 72 of the administrator terminal 70 receives selection of a linking method (step S131). Subsequently, the display control unit 73 causes a display unit such as the display 718 to display a service type registration screen 370 for registering the service type (step S132). FIG. 19 is a diagram illustrating an example of the service type registration screen. The service type registration screen 370 illustrated in FIG. 19 is displayed w % ben the administrator presses the linking method selection button 331a in step S131, and is a display screen for registering a URL as a linking method. The service type registration screen 370 includes a service type registration button 371 for registering a service type (name) and a connection destination registration button 373 for registering a URL that is a connection destination of each service type. In the example illustrated in FIG. 19, attendance management and attendance registration A are registered as service types, and URLs corresponding to each of the service types is registered.

Then, the reception unit 72 of the administrator terminal 70 receives service type registration in relation to the linked service 90 according to various input operations performed on the service type registration screen 370 by the administrator (step S133). Then, the transmission/reception unit 71 transmits a service type registration request to the information processing system 10 (step S134). The service type registration request includes the service ID received in step S17, and the service types and the URL corresponding to each service type received in step S133. The transmission/reception unit 11 of the information processing system 10 receives the service type registration request transmitted from the administrator terminal 70.

Then, the registration unit 14 of the information processing system 10 registers linked service information associated with the service ID and the information on the service types received in step S134 in the linked service management DB 1001 (step 135). More specifically, the registration unit 14 registers the received service type information, which is registered in step S115 and includes the service ID same as the one received in step S134, in association with the received information on the service types. In addition, the registration unit 14 registers the connection service information associated with the service type received in step S134 and the information on the URL corresponding to the service type in the connection service management DB 1005 (see FIG. 10) (step S136). As described above, the information processing system 10 registers connection destinations that are different from each other according to a service type with respect to the linked service 90 that is available through the touch point 40.

Returning again to FIG. 14, when the registration process of the condition for linking with the linked service 90 ends in response to a predetermined input operation performed by the administrator (YES in step S35), the administrator terminal 70 ends the process and repeats the processing from step S33 until the condition registration process ends (NO in step S35). In FIG. 14, the order of the processing of step S33 and the processing of step S34 is changeable.

As described above, the information processing system 10 registers, for each touch point 40, information on the user and information on content of the service type that are corresponding to the attribute type used when the user uses the linked service 90 through the touch point 40.

Process of Setting Linked Service:

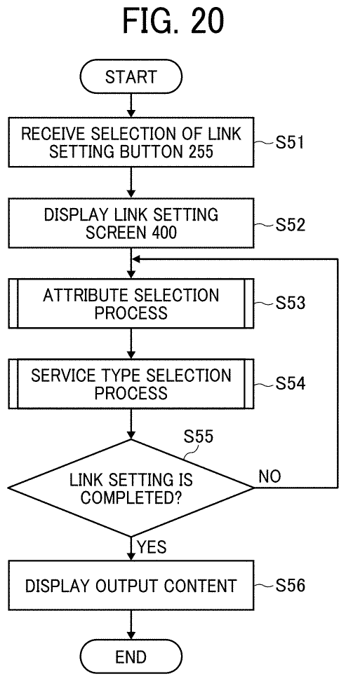

A process of setting a service type and an attribute type in the linked service 90 registered in the above-described process is described blown with reference to FIG. 20 to FIG. 29. FIG. 20 is a flowchart illustrating an example of the process of setting for a linked service.

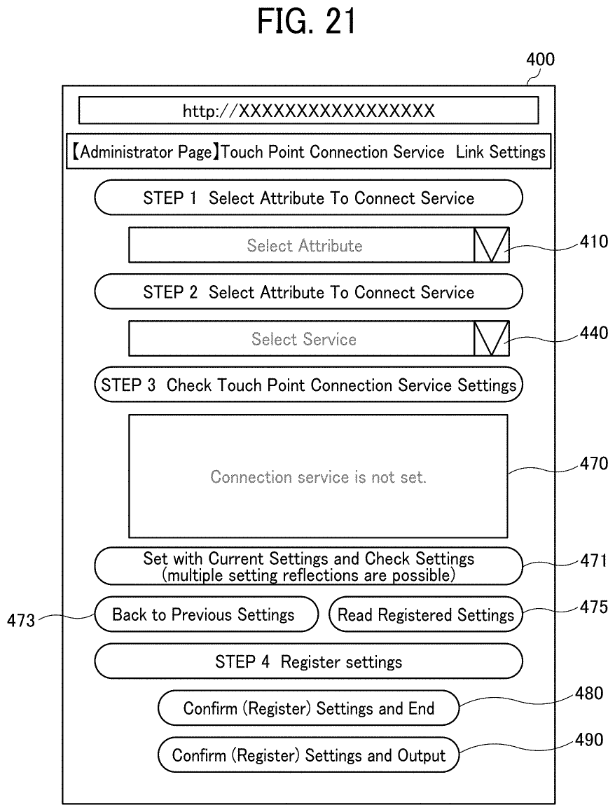

The reception unit 72 of the administrator terminal 70 receives selection of a link setting button 255 included in the top screen 250 by an input operation of the administrator (step S51). Subsequently, the display control unit 73 causes a display unit such as the display 718 to display a link setting screen 400 for a link setting with respect to the linked service 90 (step S32). FIG. 21 is a diagram illustrating an example of the link setting screen. The link setting screen 400 illustrated in FIG. 21 includes an attribute selection button 410 for selecting an attribute for a link setting, and a service type selection button 440 for selecting a service type for a link setting. The link setting screen 400 includes a settings display area 470 for displaying details of link settings, a setting check button 471 to be pressed for displaying the settings in a setting display area 470, a return (back) button 473 to be pressed for returning the settings to the previous state, and a setting reading button 475 to be pressed for reading the registered settings. The link setting screen 400 includes an end button 480 that is pressed for confirming the settings and ending the link setting processing, and an output button 490 that is pressed for confirming the settings and outputting the touch point 40.

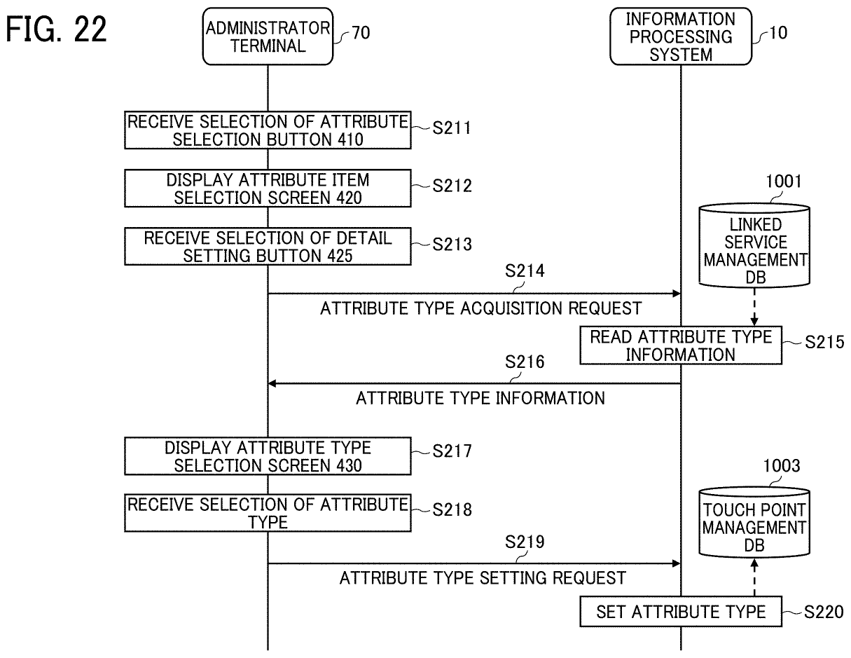

The administrator terminal 70 executes selection processing of an attribute to be linked (step S53). The processing of step S53 is described in detail below with reference to FIG. 22. FIG. 22 is a sequence diagram illustrating an example of the attribute selection process.

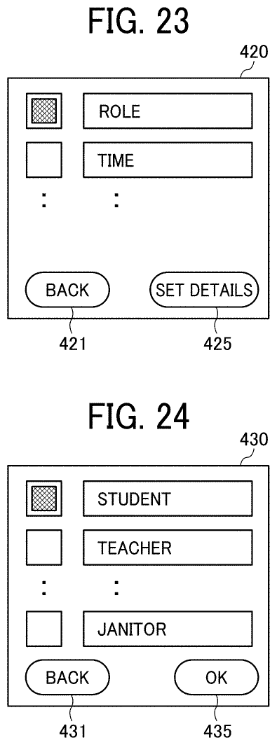

The reception unit 72 of the administrator terminal 70 receives selection of the attribute selection button 410 included in the link setting screen 400 by an input operation of the administrator (step S211). Subsequently, the display control unit 73 causes a display unit such as the display 718 to display an attribute item selection screen 420 for selecting an attribute item to be linked (step S212). FIG. 23 is a diagram illustrating an example of the attribute item selection screen. The attribute item selection screen 420 illustrated in FIG. 23 displays attribute items available to be linked, in a selectable manner. The attribute item selection screen 420 includes a back button 421 that is pressed for going back to the link setting screen 400 and a detail setting button 425 that is pressed for setting an attribute type corresponding to the selected attribute item.

Then, the reception unit 72 of the administrator terminal 70 receives selection of the detail setting button 425 included in the attribute item selection screen 420 by an input operation of the administrator (step S213). Then, the transmission/reception unit 71 transmits an attribute type acquisition request to the information processing system 10 (step S214). This attribute type acquisition request includes the information on the attribute item selected when the selection of the detail setting button 425 is received in step S213 and the service ID received in step S17. In the example of FIG. 23, the attribute type acquisition request includes information of role as the selected attribute item. In the attribute item selection screen 420, a plurality of attribute items may be selected. The transmission/reception unit 11 of the information processing system 10 receives the attribute type acquisition request transmitted from the administrator terminal 70.

Then, the storing/reading unit 19 of the information processing system 10 reads, from the linked service management DB 1001 (see FIG. 6), attribute type information indicating an attribute type corresponding to the attribute item received in step S214 among from the linked service information associated with the service ID received in step S214 (step S215). In this case, the storing/reading unit 19 reads the attribute type corresponding to the attribute item “ROLE” from the linked service information stored in the linked service management DB 1001. Then, the transmission/reception unit 11 transmits the attribute type information read in step S215 to the administrator terminal 70 that is the request source (step S216). The transmission/reception unit 71 of the administrator terminal 70 receives the attribute type information transmitted from the information processing system 10.

Subsequently, the display control unit 73 of the administrator terminal 70 causes a display unit such as the display 718 to display an attribute type selection screen 430 for selecting an attribute type to be linked (step S217). FIG. 24 is a diagram illustrating an example of the attribute type selection screen. The attribute type selection screen 430 illustrated in FIG. 24 displays attribute types indicated in the attribute type information received in step S216, in a selectable manner. The attribute type selection screen 430 includes a back button 431 that is pressed for going back to the attribute item selection screen 420 and an OK button 435 that is pressed for setting an attribute.

Then, the reception unit 72 of the administrator terminal 70 receives the selection of the attribute type according to operations performed by the administrator of selecting an attribute type and pressing the OK button 435 (step S218). Then, the transmission/reception unit 71 transmits an attribute type acquisition request to the information processing system 10 (step S219). This attribute setting request includes information on the attribute type selected in step S218. In the example of FIG. 24, the attribute setting request includes information of student as the selected attribute type. The transmission/reception unit 11 of the information processing system 10 receives the attribute type setting request transmitted from the administrator terminal 70.

Then, the setting unit 15 of the information processing system 10 sets the attribute type information received in step S219 in association with the service ID received in step S214 in the touch point management DB 1003 (see FIG. 8) (step S220).

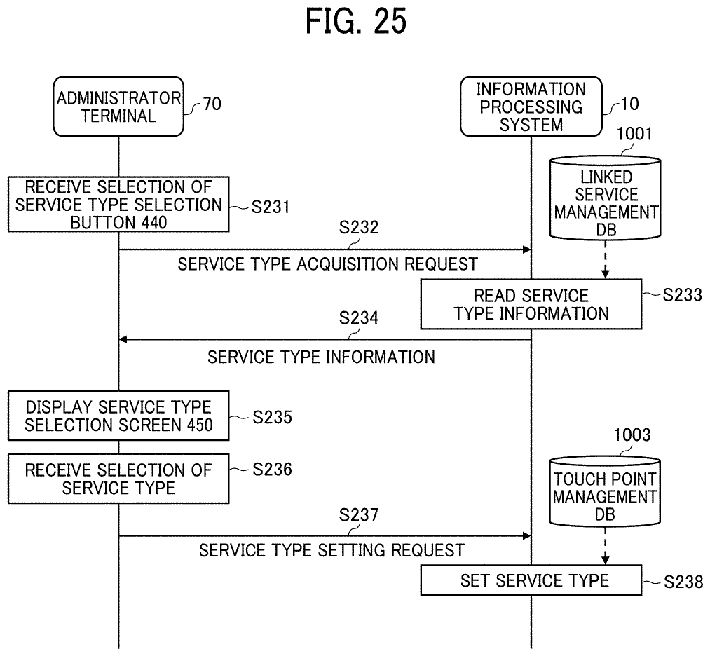

Returning again to FIG. 20, the administrator terminal 70 executes a process of selecting a service type to be linked with the attribute type set in step S53 (step S54). The processing of step S54 is described in detail below with reference to FIG. 25. FIG. 25 is a sequence diagram illustrating an example of the service type selection process.

The reception unit 72 of the administrator terminal 70 receives selection of the service type selection button 440 included in the link setting screen 400 by an input operation of the administrator (step S231). Then, the transmission/reception unit 71 transmits a service type acquisition request to the information processing system 10 (step S232). This service type acquisition request includes the service ID received in step S17. The transmission/reception unit 11 of the information processing system 10 receives the service type acquisition request transmitted from the administrator terminal 70.

Then, the storing/reading unit 19 of the information processing system 10 reads, from the linked service management DB 1001 (see FIG. 6), service type information indicating a service type included in linked service information associated with the service ID received in step S232 (step S233). Then, the transmission/reception unit 11 transmits the service type information read in step S233 to the administrator terminal 70 that is the request source (step S234). The transmission/reception unit 71 of the administrator terminal 70 receives the service type information transmitted from the information processing system 10.

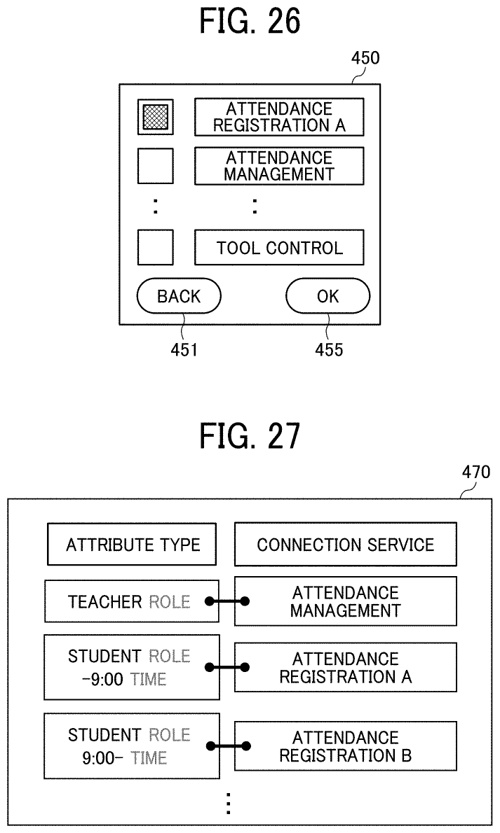

Subsequently, the display control unit 73 of the administrator terminal 70 causes a display unit such as the display 718 to display a service type selection screen 450 for selecting a service type to be linked with the attribute type set in step S53 (step S235). FIG. 26 is a diagram illustrating an example of the service type selection screen. The service type selection screen 450 illustrated in FIG. 26 displays service types indicated by the service type information received in step S235, in a selectable manner. The service type selection screen 450 includes a back button 451 that is pressed for going back to the link setting screen 400 and an OK button 455 that is pressed for setting a service type.

Then, the reception unit 72 of the administrator terminal 70 receives the selection of the service type according to operations performed by the administrator of selecting a service type and pressing the OK button 455 (step S236). Then, the transmission/reception unit 71 transmits a service type setting request to the information processing system 10 (step S237). This service type setting request includes information on the service type selected in step S236. In the example illustrated in FIG. 26, the service type setting request includes information of attendance registration A as the selected service type. The transmission/reception unit 11 of the information processing system 10 receives the service type setting request transmitted from the administrator terminal 70.

Then, the setting unit 15 of the information processing system 10 sets the service type information received in step S237 in association with the attribute type set in step S220 in the touch point management DB 1003 (see FIG. 8) (step 238). As described above, the information processing system 10 sets a combination of an attribute type and a service type for the linked service 90 used through the touch point 40.

Returning again to FIG. 20, when the link setting is ended in response to an operation performed by the administrator of selecting the end button 480 or the output button 490 (YES in step S55), the administrator terminal 70 shifts the processing to step S56 and repeats the processing from step S53 until the link setting is ended (NO in step S55). The administrator terminal 70 repeats the processing from step S53 for each attribute type in the linked service 90, and associates the attribute type and the service type with respect to the touch point management DB 1003. In this case, the setting unit 15 assigns the same touch point ID for identifying a touch point in association with each combination of the attribute type and the service type set by the series of link settings and stores the touch point ID in the touch point management DB 1003.

FIG. 27 is a diagram illustrating an example of the settings displayed in the setting display area. The setting display area 470 illustrated in FIG. 27 is displayed on the link setting screen 400 in response to selection of the setting check button 471 performed by the administrator. In the example of FIG. 27, each combination of the attribute type and the service type set in the process of FIG. 20 is displayed in the setting display area 470. As illustrated in FIG. 27, a service type “ATTENDANCE MANAGEMENT” that is the connection service is associated with an attribute type “TEACHER” that is an attribute item of role. In addition, a service type “ATTENDANCE REGISTRATION A” that is a connection service is associated with an attribute type “STUDENT” that is an attribute item of role and another attribute type “−9:00” that is an attribute item of time. In addition, a service type “ATTENDANCE REGISTRATION B” that is a connection service is associated with the attribute type “STUDENT” that is the attribute item of role and another attribute type “9:00−” that is the attribute item of time. The settings displayed in the setting display area 470 are set as information associated with the same touch point ID in the touch point management DB 1003 in the above-described processing.

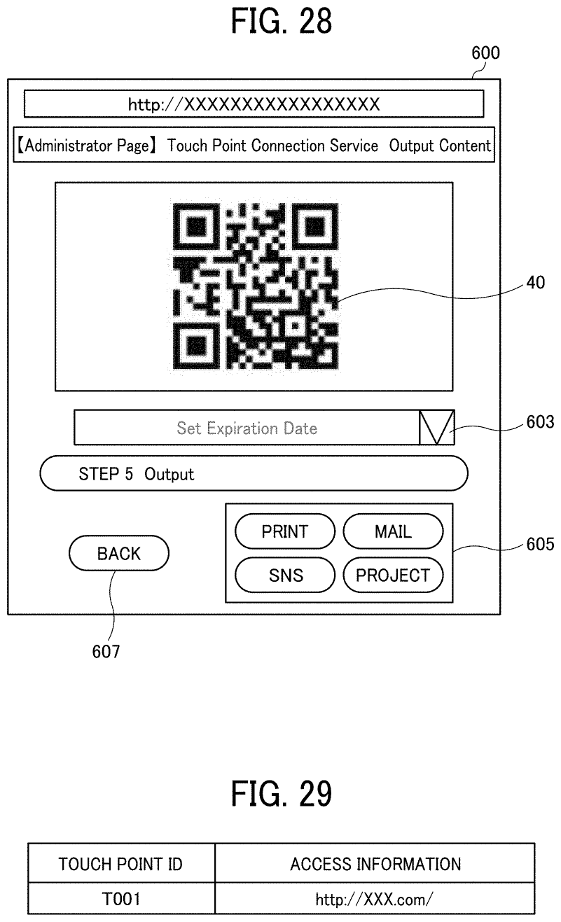

Then, when the administrator selects the output button 490 to end the link setting, the display control unit 73 of the administrator terminal 70 causes a display unit such as the display 718 to display an output content display screen 600 for displaying output content of the link setting (step S56). FIG. 28 is a diagram illustrating an example of the output content display screen. The output content display screen 600 illustrate in FIG. 28 includes an image indicating the touch point 40, an expiration date setting button 603 for setting an expiration date of the touch point 40, an output method selection button 605 for selecting an output method of the touch point 40, and a back button 607 to be pressed for going back to the link setting screen 400.

The image indicating the touch point 40 included in the output content display screen 600 of FIG. 28 is an image serving as an output result in which the touch point information created by the generating unit 16 is output by the output unit 17. The image indicating the touch point 40 is a QR code (registered trademark). Note that the image indicating the touch point 40 is not limited to the QR code, and may be a two-dimensional code such as DataMatrix (DataCode), MaxiCode, or PDF417. The touch point 40 is set at a predetermined position in the user environment according to operations performed by the administrator for outputting the image indicating the touch point 40 by a method selected by the output method selection button 605. For example, the administrator prints out the image indicating the touch point 40 and attaches the image indicating the touch point on a desired position in the user environment, and the user reads the image indicating the touch point 40, accordingly.

Note that the touch point 40 is not limited to the image such as the two-dimensional code as described above. The touch point 40 may be a touch point using short-range communication by an NFC tag or an RFID tag, for example. The touch point 40 may be a touch point using near field communication such as Bluetooth or ultrasonic waves, for example. The output content display screen 600 illustrated in FIG. 28 is an example of a case where the touch point 40 is an image. When the touch point 40 has a form other than an image, a user interface (UI) screen corresponding to the form of the touch point 40 is displayed.

FIG. 29 is a diagram illustrating an example of the touch point information. The touch point information illustrated in FIG. 29 is, for example, information acquired when the user reads the touch point 40 using the user terminal 50. The touch point information includes a touch point ID for identifying the touch point 40 and access information indicating an access destination to be accessed by the user terminal 50 when the touch point 40 is read. This access information is a URL to be accessed with the user terminal 50 that has read the touch point 40.

As described above, the information processing system 10 sets a service type that is to be used by a user for each attribute type of user to each touch point 40 in the linked service 90, which is available through the touch point 40. In addition, the information processing system 10 can dynamically change the service provided to the user via the touch point 40 by changing the settings of the combination of the attribute type and the service type.

Process for Using Service:

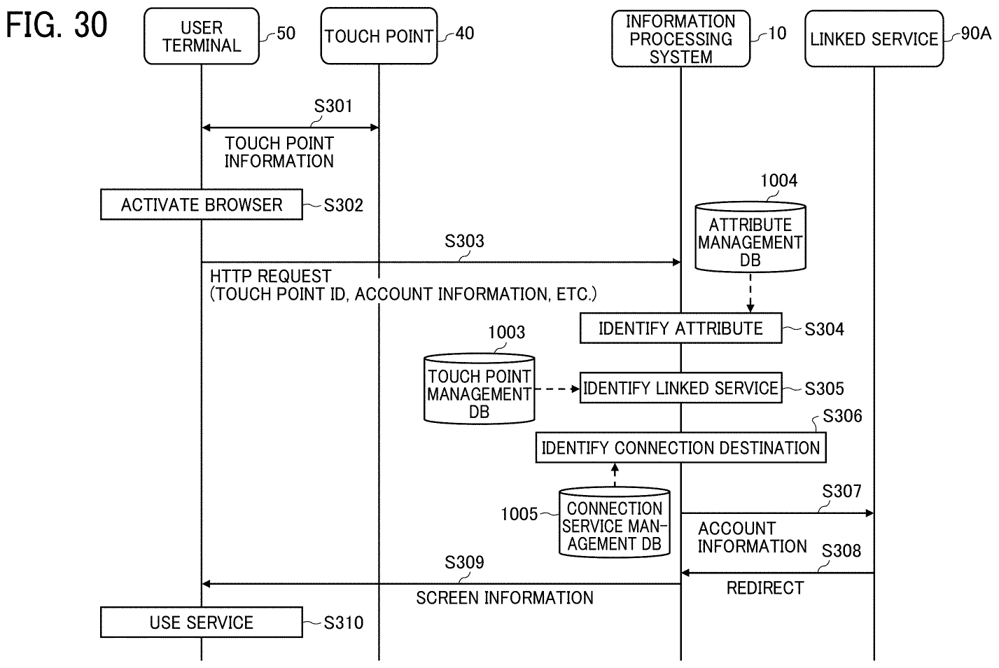

A process for using a service provided through a touch point is described below with reference to FIG. 30 to FIG. 38. FIG. 30 is a sequence diagram illustrating an example of the process for using a service. In the example of FIG. 30, a case in which the user uses a predetermined service by reading with the user terminal 50 the touch point 40 set with the information processing system 10 by the above-described processing is described.

The user hangs the user terminal 50 close to the touch point 40 set in a user environment, and takes photo of the touch point 40 using the user terminal 50, thereby an image representing the touch point 40 is captured. Then, the touch point reading unit 52 of the user terminal 50 acquires touch point information by decoding the captured image representing the touch point 40 using the conversion unit 53 (step S301). The touch point information includes, as illustrated in FIG. 29, a touch point ID for identifying the touch point 40 and access information indicating an access destination to be accessed by the user terminal 50 when the touch point 40 is read. The touch point information acquired in step S301 is an example of read information.

Then, the touch point reading unit 52 of the user terminal 50 automatically activates the browser unit 51 by inputting the access information included in the touch point information acquired in step S301 (step S302). Then, the browser unit 51 of the user terminal 50 transmits a Hyper Text Transfer Protocol (HTTP) request to the access destination (information processing system 10) indicated by the access information acquired in step S301 (step S303). This HTTP request includes, for example, the touch point ID included in the touch point information acquired in step S301, the account information for identifying the user. The account information is, for example, a cookie stored in association with the access information in the user terminal 50 in the past when the user terminal 50 accesses the access destination. The transmission/reception unit 11 of the information processing system 10 that is the access destination receives the HTTP request transmitted from the user terminal 50.

Then, the identifying unit 21 searches the attribute management DB 1004 (see FIG. 9) using the touch point ID and the account information received in step S303 as search keys to identify the attribute of the user who uses the user terminal 50 that has read the touch point 40 (step S304). In addition, the identifying unit 21 searches the touch point management DB 1003 (see FIG. 8) using the touch point ID received in step S303 and the attribute type of the user specified in step S304 as search keys to identify a service type that is a connection service (step S305). Then, the identifying unit 21 searches the connection service management DB 1005 (see FIG. 10) using the touch point ID received in step S303 and the service type identified in step S305 as search keys to extract connection destination information, thereby identifying a connection destination for using the linked service 90 (step S306).

Then, the service providing unit 12 transmits the account information received in step S303 to the URL (linked service 90) corresponding to the connection destination identified in step S306 (step S307). Then, the linked service 90 performs user authentication using the account information transmitted form the information processing system 10 and causes the information processing system 10, which is the request source, to redirect to the received account information (step S308).

The service providing unit 12 of the information processing system 10 transmits screen information to the user terminal 50, which is the request source, based on the information transmitted from the linked service 90 in step S308 (step S309). Then, the browser unit 51 of the user terminal 50 starts using the service based on the screen information transmitted from the information processing system 10 (step S310). The display control unit 55 of the user terminal 50 causes a display unit such as the display 518 to display a service use screen implemented by the browser unit 51. Then, the user uses the service provided from the linked service 90 by using the service use screen displayed on the user terminal 50. Accordingly, the service use system 1 allows the user to use the service corresponding to the attribute of the user provided from the linked service 90 based on the touch point information read by the user terminal 50.

Case that Service to be Provided Varies According to Role:

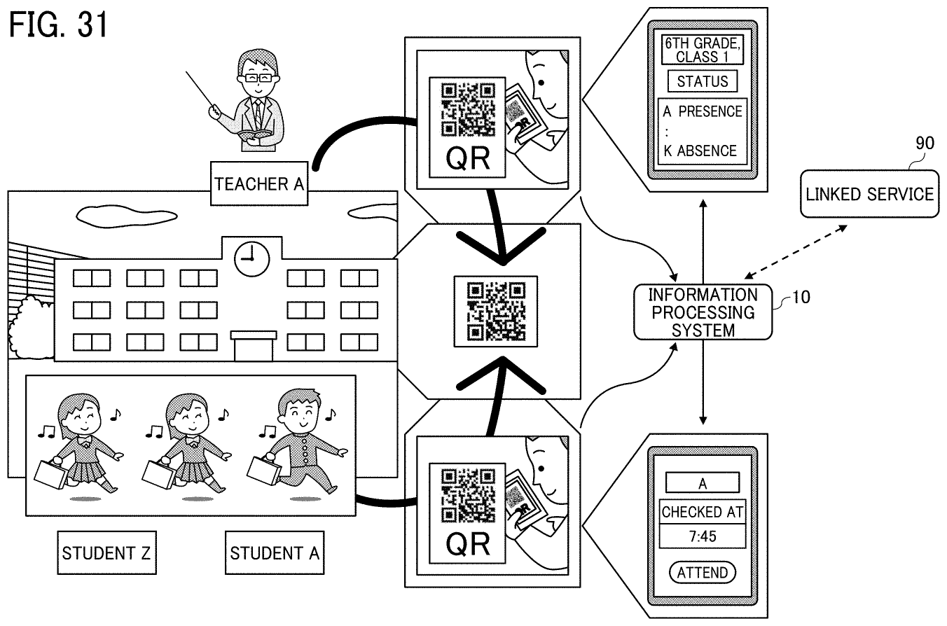

Specific examples of the process for using a service in the service use system is described with reference to FIG. 31 to FIG. 38. A case that a service to be provided varies according to a role of user, which is an example of the attribute item, is described below with reference to FIG. 31 to FIG. 33. FIG. 31 is a schematic diagram illustrating an example of the attendance management service provided in the service use system.

In the example of FIG. 31, services each of which is provided to the corresponding user when the touch point 40 corresponding to the attendance management service (service ID: S001), which is an example of the linked service 90, is read by users each having a corresponding one of the attributes that are different from each other.

First, when a teacher A reads the touch point 40, a service of “ATTENDANCE MANAGEMENT” that is a service type in the attendance management service is provided to the user terminal 50 used by the teacher A. The teacher A manages attendance of students using a service use screen displayed on the user terminal 50.

When students (student A and student Z) read the touch point 40 that is the same as one read by the teacher A, a service of “ATTENDANCE REGISTRATION A” that is a service type in the attendance management service is provided to the user terminal 50 used by each student. Each of the student A and the student Z performs attendance registration by using a service use screen displayed on the corresponding user terminal 50.

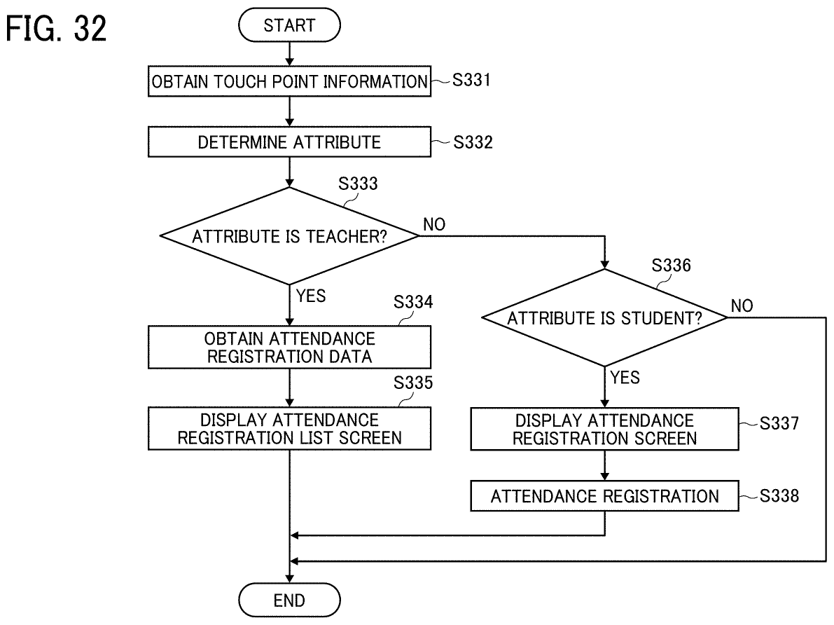

FIG. 32 is a flowchart illustrating an example of the process for using a service in a case where different services are provided according to an attribute item of role. In the example of FIG. 32, an example in which the attendance management service is provided through the touch point 40 as illustrated in FIG. 31 is used.

First, as illustrated in step S301 of FIG. 30, the touch point reading unit 52 of the user terminal 50 obtains touch point information by reading the touch point 40 set at an entrance of a school gate or a classroom, for example (step S331). Subsequently, as illustrated in step S304 of FIG. 30, the identifying unit 21 of the information processing system 10 determines an attribute of a user who has read the touch point 40 based on the touch point ID transmitted from the user terminal 50 and account information of the user (step S332).

When the attribute of the user who has read the touch point 40 is the teacher (YES in step S333), the information processing system 10 shifts the process to step S334. As illustrated in steps S305 to S309 of FIG. 30, the browser unit 51 of the user terminal 50 used by the teacher obtains attendance registration information provided from the attendance management service based on the service type “ATTENDANCE MANAGEMENT” associated with the attribute type of the teacher in the touch point management DB 1003 of the information processing system 10 (step S334). Subsequently, the display control unit 55 of the user terminal 50 causes a display unit such as the display 518 to display an attendance registration list screen as a service use screen based on obtained attendance registration data (step S335).

Accordingly, reading the touch point 40 with the user terminal 50 of the teacher allows the teacher to view the attendance registration list screen displayed on the user terminal 50 and check attendance statues of the students.

On the other hand, when the attribute of the user who has read the touch point 40 is not the teacher (NO in step S333), the information processing system 10 shifts the process to step S336. If the attribute of the user who has read the touch point 40 is the student (YES in step S336), the information processing system 10 shifts the process to step S337. When the attribute of the user who has read the touch point 40 is not the student (NO in step S336), the information processing system 10 ends the process, or performs substantially the same processing of determination in relation to another attribute type registered in association with the touch point 40, if any.

As illustrated in steps S305 to S309 of FIG. 30, the browser unit 51 of the user terminal 50 used by the student obtains screen information of attendance registration screen provided from attendance management service, based on the service type “ATTENDANCE MANAGEMENT” associated with the attribute type of the student in the touch point management DB 1003 of the information processing system 10. Subsequently, the display control unit 55 of the user terminal 50 causes a display unit such as the display 518 to display an attendance registration screen as a service use screen based on the obtained screen information (step S337). Accordingly, with the attendance management service, attendance registration of the student is performed in response to an input operation performed by the student on the attendance registration screen (step S338). Accordingly, reading the touch point 40 with the user terminal 50 of the student allows the student to perform the attendance registration from the attendance registration screen displayed on the user terminal 50.

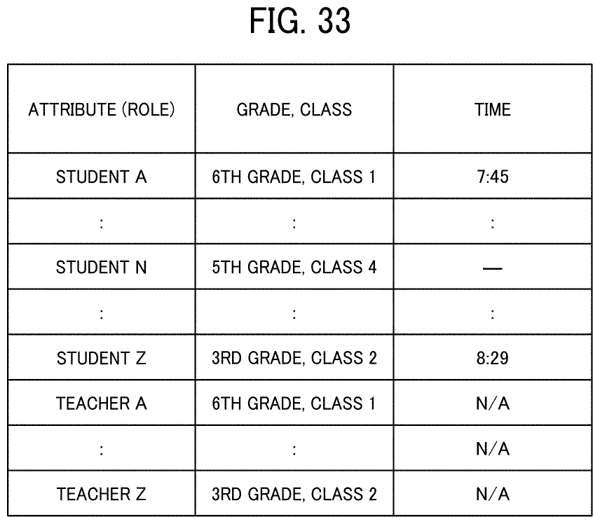

FIG. 33 is a diagram illustrating an example of the attendance registration information registered by the attendance management service. The attendance registration information illustrated in FIG. 33 includes information registered by each student in the processing of step S338 and is provided to the user terminal 50 used by the teacher in the processing of step S334.

As described above, in the attendance management service that is an example of the linked service 90, when the same touch point 40 is read by users each of who has a corresponding one of attributes, which are different from each other, (for example, teacher or student), the service use system 1 cause each of the user terminals 50 to access a corresponding one of the connection destinations that varies according to the attribute type of the user and allows each user to use the corresponding service.

Case that Service to be Provided Varies According to Role and Time:

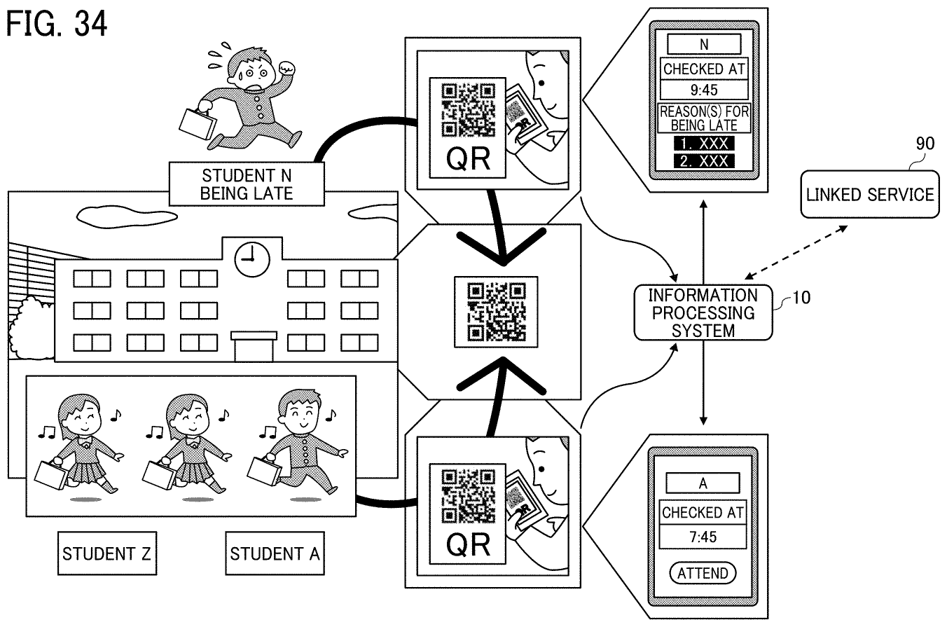

A case that a service to be provided varies according to a role of user and a touch point reading time, each of which is an example of the attribute item, is described below with reference to FIG. 34 to FIG. 36. FIG. 34 is a schematic diagram illustrating an example of the attendance management service provided in the service use system.

In the example of FIG. 34, a service provided to the students when the touch point 40 corresponding to the attendance management service (service ID: S001), which is an example of the linked service 90, is read by each student varies according to a reading time at which the touch point 40 is read.

When the students (student A and student Z) who come to school by a start time (for example, 9:00) and read the touch point 40 before the start time or at the start time, the service of “ATTENDANCE REGISTRATION A” that is a service type in the attendance management service is provided to the user terminals 50 used by the student A and the student Z. Each of the student A and the student Z perform attendance registration by using a service use screen displayed on the corresponding user terminal 50, in substantially the same manner as the case illustrated in FIG. 31.

On the other hand, when a student N who is late reads, after the start time, the same touch point 40 as the one read by the student A and the student Z, a service of “ATTENDANCE REGISTRATION B” that is a service type in the attendance management service is provided to the user terminal 50 used by the student N. The student N uses a service provision screen that is different from the one displayed on the user terminal 50 of the student A or the student Z and allows the student N to register information including a school attendance time and a reason for being late, for example.

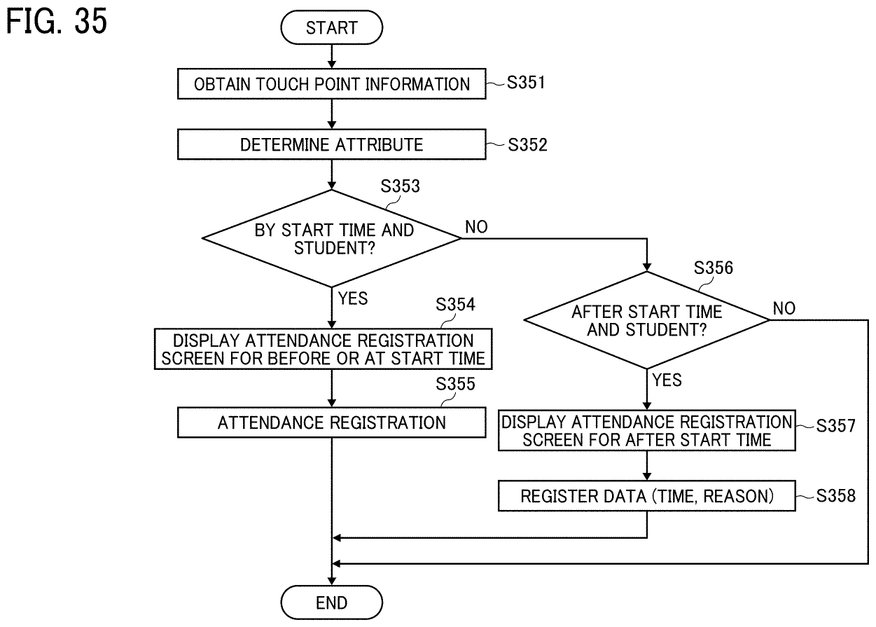

FIG. 35 is a flowchart illustrating an example of the process for using a service in a case where different services are provided according to attribute items of role and time. In the example of FIG. 35, an example in which the attendance management service is provided through the touch point 40 as illustrated in FIG. 34 is used.

First, as illustrated in step S301 of FIG. 30, the touch point reading unit 52 of the user terminal 50 obtains touch point information by reading the touch point 40 set at an entrance of a school gate or a classroom, for example (step S351). Subsequently, as illustrated in step S304 of FIG. 30, the identifying unit 21 of the information processing system 10 determines an attribute of a user who has read the touch point 40 based on the touch point ID transmitted from the user terminal 50 and account information of the user (step S352).

When the attribute of the user who has read the touch point 40 is the student and a reading time at which the touch point 40 is read is within a time zone or by a time, namely before or at a start time, indicated by the attribute type (for example, −9:00) (YES in step S353), the information processing system 10 causes the process to proceed to step S354. As illustrated in steps S305 to S309 of FIG. 30, the browser unit 51 of the user terminal 50 used by the student obtains screen information of attendance registration screen for students who come by a start time provided from attendance management service, based on the service type “ATTENDANCE REGISTRATION A” associated with the attribute types of the student and the reading time in the touch point management DB 1003 of the information processing system 10. Subsequently, the display control unit 55 of the user terminal 50 causes a display unit such as the display 518 to display the attendance registration screen for students who come by a start time as a service use screen based on the obtained screen information (step S354). Accordingly, with the attendance management service, attendance registration of the student is performed in response to an input operation performed by the student on the attendance registration screen for students who come by a start time (step S355).

Accordingly, reading the touch point 40 with the user terminal 50 of the student allows the student who comes before or at a start time to perform the attendance registration from the attendance registration screen displayed on the user terminal 50.

On the other hand, when the attribute of the user who has read the touch point 40 is the student and a reading time at which the touch point 40 is read is not within the time zone, namely after the start time, indicated by the attribute type (for example, 9:00−) (NO in step S353), the information processing system 10 causes the process to proceed to step S356. When the attribute of the user who has read the touch point 40 is the student and the reading time at which the touch point 40 is read is not within the time zone, namely after the time, indicated by the attribute type (for example, 9:00−) (YES in step S356), the information processing system 10 causes the process to proceed to step S357. When the attribute of the user who has read the touch point 40 is not the student (NO in step S356), the information processing system 10 ends the process, or performs substantially the same processing of determination in relation to another attribute type registered in association with the touch point 40, if any.

As illustrated in steps S305 to S309 of FIG. 30, the browser unit 51 of the user terminal 50 used by the student who is being late obtains screen information of attendance registration screen for students who are late provided from attendance management service, based on the service type “ATTENDANCE REGISTRATION B” associated with the attribute types of the student and the reading time in the touch point management DB 1003 of the information processing system 10. Subsequently, the display control unit 55 of the user terminal 50 causes a display unit such as the display 518 to display the attendance registration screen for students who are late as a service use screen based on the obtained screen information (step S357). Accordingly, with the attendance management service, an arriving time or a reason for being late is registered in response to an input operation performed by the student on the attendance registration screen for students who are late (step S358).

Accordingly, reading the touch point 40 with the user terminal 50 of the student who is late allows the student who comes after a start time to register information on a reason for being late in addition to perform the attendance registration by using the attendance registration screen that is different from the one used by other students who comes by a start time and that is displayed on the user terminal 50.

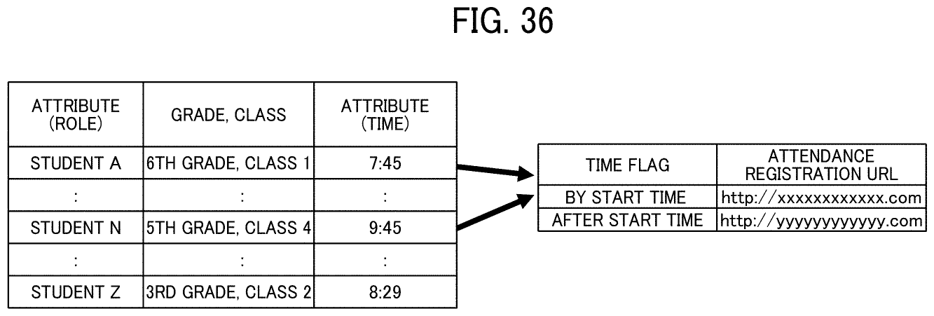

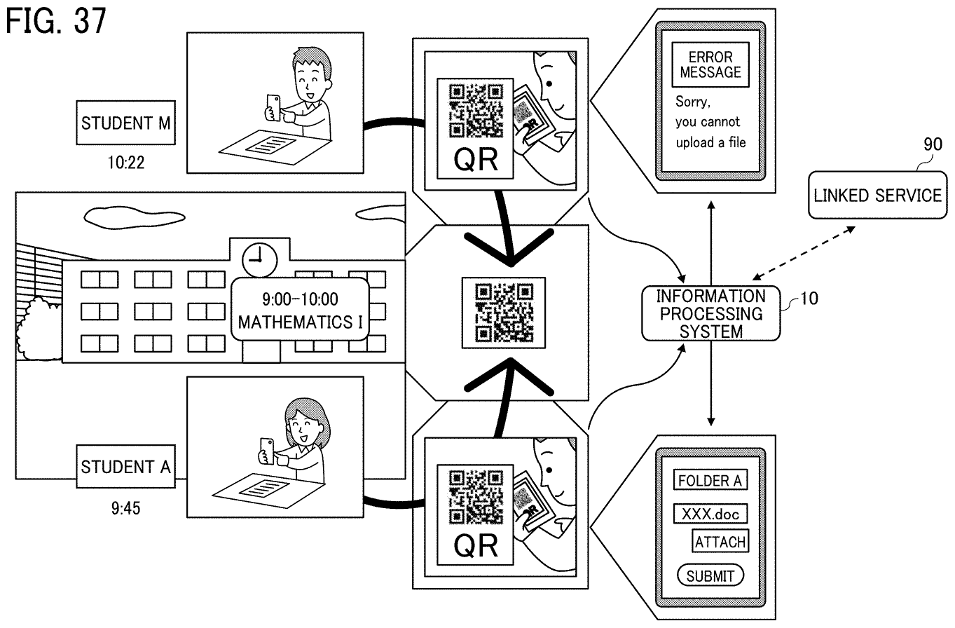

FIG. 36 is a diagram illustrating an example of the attendance registration information registered by the attendance management service. The attendance registration information illustrated in FIG. 36 includes information registered by each student in the processing of step S355 and the processing of step S358. As illustrated in FIG. 36, an URL for attendance registration guided to the student A who has read the touch point 40 before or at the start time and an URL for attendance registration guided to the student N who has read the touch point 40 after the start time are different from each other according to a time flag even when the same touch point 40 is read, and each of different service use screens is displayed on the corresponding user terminal 50.

As described above, in the attendance management service that is an example of the linked service 90, even when the same touch point 40 is read by users who has the same attribute (for example, student), the service use system 1 cause each of the user terminals 50 to access a corresponding one of the connection destinations that varies according to a time at which the touch point 40 is read and allows each user to use the corresponding service.

Case that Time Limit is Set for Service:

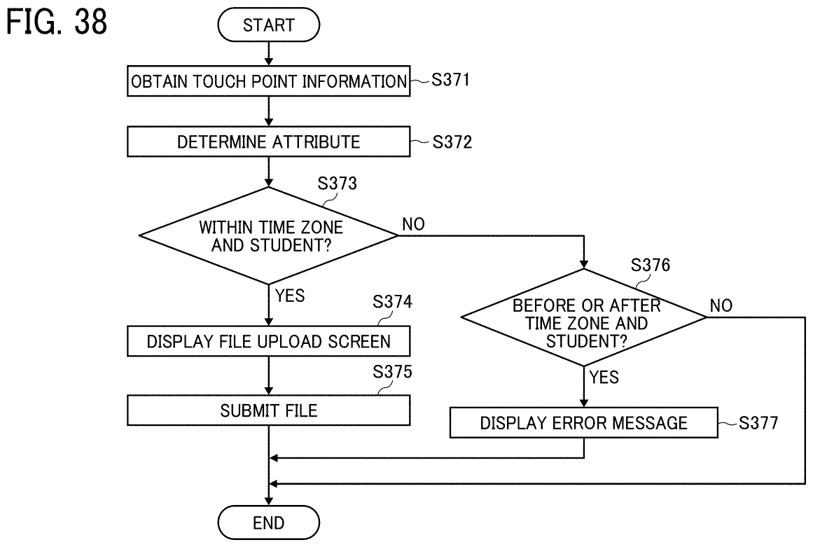

A case that using a service through a touch point has a time limit is described below with reference to FIG. 37 and FIG. 38. FIG. 37 is a schematic diagram illustrating an example of a submitting service provided in the service use system.

In the example of FIG. 37, when the touch point 40 corresponding to the submitting service (service ID: S003), which is an example of the linked service 90, a time limit is set for a service to be provided according to a time at which the touch point 40 is read. In the example of FIG. 37, each of the student A and a student M attends a lecture “MATHEMATICS I” from 9:00 to 10:00, reads the touch point 40 printed on an answer sheet during the lecture, and submit an electronic file of the answer sheet.

First, when the student A reads the touch point 40 during the lecture, for example, at 9:45, a service of “FOLDER A” that is a service type in the submitting service is provided to the user terminal 50 used by the student A. The student A submits an electronic file of the answer sheet using a service use screen displayed on the user terminal 50.

On the other hand, in a case where the student M reads the touch point 40, which is the same as one read by the student A, before or after the lecture, for example, at 10:22, an error message indicating that the submitting service is not available is displayed on the user terminal 50 used by the student M. When the error message is displayed on the user terminal 50, the student M fails to submit the answer sheet.

FIG. 38 is a flowchart illustrating an example of a process for using a service in a case where different services are provided according to attribute items of role and time. In the example of FIG. 38, an example in which the submitting service is provided through the touch point 40 as illustrated in FIG. 37 is used.

First, as illustrated in step S301 of FIG. 30, the touch point reading unit 52 of the user terminal 50 obtains touch point information by reading the touch point 40 printed on an answer sheet, for example (step S371). Subsequently, as illustrated in step S304 of FIG. 30, the identifying unit 21 of the information processing system 10 determines an attribute of a user who has read the touch point 40 based on the touch point ID transmitted from the user terminal 50 and account information of the user (step S372).

When the attribute of the user who has read the touch point 40 is the student and a reading time at which the touch point 40 is read is within a time zone indicated by the attribute type (for example, 9:00-10:00) (YES in step S373), the information processing system 10 causes the process to proceed to step S374. As illustrated in steps S305 to S309 of FIG. 30, the browser unit 51 of the user terminal 50 used by the student obtains screen information of file upload screen used to submit in the submitting service, based on the service type “FOLDER A” associated with the attribute types of the student and the reading time in the touch point management DB 1003 of the information processing system 10. Subsequently, the display control unit 55 of the user terminal 50 causes a display unit such as the display 518 to display a file upload screen as a service use screen based on the obtained screen information (step S374). Accordingly, with the submitting service, an electronic file of answer sheet is submitted in response to an input operation performed by the student on the file upload screen (step S375).

Accordingly, reading the touch point 40 during a lecture with the user terminal 50 of a student allows the student to submit an answer sheet from the file upload screen displayed on the user terminal 50.

On the other hand, when the attribute of the user who has read the touch point 40 is the student and a reading time at which the touch point 40 is read is within the time zone indicated by the attribute type (for example, 9:00-10:00) (NO in step S373), the information processing system 10 causes the process to proceed to step S376. When the attribute of the user who has read the touch point 40 is the student and the reading time at which the touch point 40 is read is not within the time zone, namely before or after a time, indicated by the attribute type (YES in step S376), the information processing system 10 causes the process to proceed to step S377. When the attribute of the user who has read the touch point 40 is not the student (NO in step S376), the information processing system 10 ends the process, or performs substantially the same processing of determination in relation to another attribute type registered in association with the touch point 40, if any.

As illustrated in steps S305 to S309 of FIG. 30, the browser unit 51 of the user terminal 50 used by the student obtains screen information related to an error message indicating that the submitting service is unavailable. Subsequently, the display control unit 55 of the user terminal 50 causes a display unit such as the display 518 to display an error message based on the obtained screen information (step S377).

Accordingly, reading the touch point 40 before or after a lecture with the user terminal 50 of a student does not allow the student to submit an answer sheet, by displaying an error message on the user terminal 50 instead of displaying the file upload screen, resulting in limiting the use of the service.

As described above, in the submitting service that is an example of the linked service 90, even when the same touch point 40 is read by users who has the same attribute (for example, student), the service use system 1 sets a time limit for using a service according to a reading time at which the touch point 40 is read. More specifically, the service use system 1 allows users who has read the touch point 40 within a time zone set to use the service, but does not allow users who has read the touch point 40 before or after the time zone to use the service.

As illustrated in FIGS. 31 to 38, the service use system 1 provides to each user a corresponding one of the different services according to an attribute or an operation record (for example, reading time) of the user who has read the touch point 40, based on a combination of the attribute type and the service type set with the information processing system 10. The linked services illustrated in FIG. 31 to FIG. 38 are examples of various services used in a school, and even in a case of different linked services, each service is available in a substantially same manner by setting, for example, an attribute type with the information processing system 10 in advance.

As described above, the service use system 1 sets a service type that is to be used for each attribute type of user to each touch point 40 in the linked service 90, which is available through the touch point 40. Accordingly, the service use system 1 provides the touch point 40 that provides different services according to how or when to use a service in relation to each user. In addition, the service use system 1 dynamically changes the service to be provided to each user through the touch point 40 by setting different combinations of the attribute type and the service type in the information processing system 10.

The service use system 1 provides a corresponding one of the different services according to an attribute or an operation record of each user who has read the touch point 40, based on the settings set with the information processing system 10.

In the above description of the embodiment, a school is used as an example of the user environment in which the touch point 40 is set, but this is not limiting. Examples of the user environment in which the touch point 40 is set include an office, a factory, a warehouse, a work site where construction or inspection work is performed, a store, a commercial facility, a hospital, a nursing facility, public transportation, and a home. Even in such a user environment, the service use system 1 provides a service to each user through the touch point 40 by setting, with the information processing system 10 in advance, a combination of an attribute type and a service type corresponding to content of the linked service 90, which is provided in accordance with a user environment.

In a related art, a service specified from a touch point, such as a QR code, that is a contact point between a user and the service is fixed in advance, and the service to be provided does not vary for each user.

According to one of the embodiments of the present disclosure, a touch point through which a type of a service to be provided varies according to a user is provided.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions.

Each of the tables of the above-described embodiments may be generated by learning effect of machine learning. In addition, in alternative to using the tables, the data of each related item may be classified by the machine learning. In the present disclosure, the machine learning is defined as a technology that makes a computer to acquire human-like learning ability. In addition, the machine learning refers to a technology in which a computer autonomously generates an algorithm used for determination such as data identification from learning data loaded in advance and applies the generated algorithm to new data to make a prediction. Any suitable learning method is applied for the machine learning, for example, any one of supervised learning, unsupervised learning, semi-supervised learning, reinforcement learning, and deep learning, or a combination of two or more of these learning.

Although the information processing system, the service use system, the information processing method, and the program according to one or more embodiments of the present disclosure have been described above, the present disclosure may be modified within the scope of those skilled in the art, such as other embodiments, additions, modifications, deletions, etc., and as long as effects of the present disclosure are exhibited in any of the embodiments, the embodiments are included in the scope of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing system, comprising
circuitry configured to:
set, for each of a plurality of attribute types, a corresponding one of a plurality of connection destinations of a service, each of the plurality of attribute types being to be obtained from a user terminal reading a touch point through which the service is to be provided, each of the plurality of connection destinations being indicated by connection destination information with which the user terminal is to be connected to the corresponding one of the plurality of connection destinations; and
generate touch point information to be obtained in response to the user terminal reading the touch point, the touch point information including the connection destination information indicating each of the plurality of connection destinations for a corresponding one of the plurality of attribute types.

2. The information processing system of claim 1, wherein
each of the plurality of attribute types is associated with the corresponding one of the plurality of connection destinations, and includes at least one attribute item of role or time, the attribute item of role being a role of a user who uses the user terminal that reads the touch point, the attribute item of time being a time at which the touch point is read.

3. The information processing system of claim 2, wherein
the role includes a plurality of roles, and
the circuitry registers, for each of the plurality of roles, user identification information identifying a corresponding user.

4. The information processing system of claim 1, wherein
the service includes a plurality of service types each of which corresponds to the corresponding one of the plurality of connection destinations indicated by the connection destination information.

5. The information processing system of claim 1, wherein
the circuitry stores, in a memory, each of the plurality of attribute types and the corresponding one of the plurality of connection destinations in association with each other, and
outputs the touch point information based on the plurality of attribute types and the plurality of connection destinations stored in the memory.

6. The information processing system of claim 5, wherein
the touch point information is represented by an image representing the touch point, and
the image representing the touch point includes a two-dimensional code.

7. The information processing system of claim 1, wherein
the circuitry receives information obtained in reading the touch point with the user terminal,
identifies the one of the plurality of connection destinations based on the information indicating the corresponding one of the plurality of attribute types; and
provides to the user terminal the service corresponding to the one of the plurality of connection destinations.

8. The information processing system of claim 7, wherein
the user terminal includes a plurality of user terminals including a first user terminal used by a first user and a second user terminal used by a second user, and
the circuitry
identifies a first connection destination among from the plurality of connection destinations based on the information transmitted from the first user terminal and indicating a first role of the first user, and
identifies a second connection destination among from the plurality of connection destinations based on the information transmitted from the second user terminal and indicating a second role of the second user, the second role being different from the first role, and
provides the service corresponding to the first connection destination and the service corresponding to the second connection destination to the first user terminal and the second user terminal, respectively.

9. The information processing system of claim 7, wherein
the user terminal includes a plurality of user terminals including a first user terminal used by a first user and a second user terminal used by a second user, and
the circuitry
identifies a first connection destination among from the plurality of connection destinations based on the information transmitted from the first user terminal and indicating a first reading time at which the touch point is read with the first user terminal, and
identifies a second connection destination among from the plurality of connection destinations based on the information transmitted from the second user terminal and indicating a second reading time at which the touch point is read with the second user terminal, the second reading time being different from the first reading time, and
provides the service corresponding to the first connection destination and the service corresponding to the second connection destination to the first user terminal and the second user terminal, respectively.

10. The information processing system of claim 9, wherein
the second connection destination includes an error message indicating that the service is unavailable.

11. A system, comprising:
an administrator terminal including administrator terminal circuitry; and
an information processing system including information processing system circuitry,
the administrator terminal circuitry being configured to
receive input of combinations of each of a plurality of attribute types and a corresponding one of a plurality of connection destinations of a service, and
transmit, to the information processing system circuitry, the combinations of each of the plurality of attribute types and the corresponding one of the plurality of connection destinations,
the information processing system circuitry being configured to
set, for each of the plurality of attribute types, the corresponding one of the plurality of connection destinations of the service, based on the combinations of each of the plurality of attribute types and the corresponding one of the plurality of connection destinations each of the plurality of attribute types being to be obtained from a user terminal reading a touch point through which the service is to be provided, each of the plurality of connection destinations being indicated by connection destination information with which the user terminal is to be connected to the corresponding one of the plurality of connection destinations, and
generate touch point information to be obtained in response to the user terminal reading the touch point, the touch point information including the connection destination information indicating each of the plurality of connection destinations for a corresponding one of the plurality of attribute types.

12. The system of claim 11, further comprising
a user terminal including user terminal circuitry configured to
read the touch point,
transmit, to the information processing system circuitry, information obtained in reading the touch point, and
access the one of the plurality of connection destinations of the service to display a service use screen on a display.

13. An information processing method, comprising:
setting, for each of a plurality of attribute types, one of a plurality of connection destinations of a service, each of the plurality of attribute types being obtained from a user terminal reading a touch point through which the service is to be provided, each of the plurality of connection destinations being indicated by connection destination information with which the user terminal is to be connected to a corresponding one of the plurality of connection destinations; and
generating touch point information to be obtained in response to the user terminal reading the touch point, the touch point information including the connection destination information indicating each of the plurality of connection destinations corresponding one of the plurality of attribute types.

14. The information processing method of claim 13, wherein
each of the plurality of attribute types is associated with the corresponding one of the plurality of connection destinations, and includes at least one attribute item of role or time, the attribute item of role being a role of a user who uses the user terminal that reads the touch point, the attribute item of time being a time at which the touch point is read.

15. The information processing method of claim 14, wherein
the role includes a plurality of roles, and
the method further including registers, for each of the plurality of roles, user identification information identifying a corresponding user.

16. The information processing method of claim 13, wherein
the service includes a plurality of service types each of which corresponds to the corresponding one of the plurality of connection destinations indicated by the connection destination information.

17. The information processing method of claim 13, further comprising:
storing, in a memory, each of the plurality of attribute types and the corresponding one of the plurality of connection destinations in association with each other; and
outputting the touch point information based on the plurality of attribute types and the plurality of connection destinations stored in the memory.

18. The information processing method of claim 17, wherein
the touch point information is represented by an image representing the touch point, and
the image representing the touch point includes a two-dimensional code.
